(19) United States
(12) Patent Application Publication
(10) Pub. No.: US 2011/0263037 A1
(43) Pub. Date: Oct. 27, 2011

(54) POLYMERIC MATERIALS INCORPORATING CORE-SHELL SILICA NANOPARTICLES

(76) Inventors: Erik Herz, Swarthmore, PA (US); Erin Sue Hendrick, Ithaca, NY (US); Margaret W. Frey, Ithaca, NY (US); Ulrich Wiesner, Ithaca, NY (US)

(21) Appl. No.: 12/992,455

(22) PCT Filed: May 12, 2009
(86) PCT No.: PCT/US09/43608

§ 371 Date: Feb. 24, 2011

Related U.S. Application Data
(60) Provisional application No. 61/127,578, filed on May 14, 2008.

(51) Int. Cl. G01N 31/22; C09K 11/02; B82Y 15/00

(52) U.S. Cl. 436/163; 252/301.34; 977/773; 977/904

(57) ABSTRACT

Fibers, fabrics and textiles in which core-shell silica nanoparticles are incorporated are provided. The fibers, fabrics and textiles can be polymeric materials or natural cellulose-based or protein-based materials in which core-shell silica nanoparticles are incorporated. A variety of polymeric and natural materials can be employed, such as cellulose acetate, nylon, rayon, modacrylic, olefin, acrylic, polyester, polylactic acid, polylactic-co-glycolic acid (PLGA), polyurethane, aramid, wool, cotton, ramie, milk protein, soy protein, bamboo, etc. The core-shell silica nanoparticles can incorporate sensing, magnetic, thermal, electrical, chemical or RFID properties that can be imparted to the materials and that allow the materials to sense one or more conditions of interest, making them ideal for in situ sensing, treatment, or security applications.

### CROSS-REFERENCE TO RELATED APPLICATIONS

This application claims priority to and the benefit of co-pending U.S. provisional patent application Ser. No. 61/127,578, filed May 14, 2008, entitled “Polymeric materials incorporating core-shell silica nanoparticles,” which is incorporated herein by reference in its entirety.

### STATEMENT REGARDING FEDERALLY SPONSORED RESEARCH OR DEVELOPMENT

The disclosed invention was made in part with government support under agreement no. ECS-9876771 from the Science and Technology Center Program of the National Science Foundation. The government has rights in this invention.

### 1. TECHNICAL FIELD

This invention relates generally to polymeric materials incorporating nanoparticles. In particular, the invention relates to polymeric materials incorporating nanoparticles that have unique identifiers, signals or signatures. The invention also relates to polymeric materials incorporating fluorescent signals or fluorescent dyes. The invention further relates to polymeric materials incorporating nanoparticles with environmental sensitivities.

### 2. BACKGROUND OF THE INVENTION

Counterfeiting is a worldwide problem that results in the loss of hundreds of millions of dollars each year. Both consumers and producers are negatively affected by the influx of counterfeit items into the market. Corporations that produce commonly counterfeited items lose millions of dollars in revenue. For consumers, the presence of these counterfeit items increases the risk of purchasing faulty or poor quality products in place of legitimate ones. Commonly counterfeited items include clothing, documents and currency.

The International Chamber of Commerce has estimated that 7% of world trade is in counterfeit goods, approximately $350 billion (Hilton, B., Choi, C. J., Chen, S., “The ethics of counterfeiting in the fashion industry: Quality, credence and profit issues.” Journal of Business Ethics, 2004. 55: p. 344-354). To counteract this problem, anti-counterfeiting technology is constantly being developed and improved. This technology seeks to mark authentic items in a way that is very difficult, and hopefully impossible, to duplicate. However, due to the significant profit margins produced by the counterfeit market, the makers of these items are willing to spend considerable funds to keep up with new anti-counterfeiting methods (Wong, K., Hui, P., and Chan, A., “Cryptography and authentication in RFID passive tags for apparel products.” Computers in Industry, 2006. 57(4): p. 342-349). Due to this challenge, new and better anti-counterfeiting technology is constantly in demand. Specifically, there is a need in the art for anti-counterfeiting technology that is very difficult for counterfeiters to duplicate, and relatively simple for users to positively identify.

Much research has been done on the addition of a unique signal to polymeric materials. The types of signals imparted to these materials include fluorescence, magnetic, electrical, thermal, chemical, and radio frequency signals (Yan, E., Wang, C., Huang, Z., Xin, S., Tong, Y., “Synthesis and Characterization of 1D Tris(8-Quinilinolato) Aluminum Fluorescent Fibers by Electrospinning.” Materials Science and Engineering, 2007. 464: p. 59-62; Moreda, G. F., Arregui, F. J., Achaerandio, M., Matias, I. R., “Study of Indicators for the Development of Fluorescence Based Optical Fiber Temperature Sensors.” Sensors and Actuators B: Chemical 2006. 118: p. 425-432; Yu, H., Argyros, A., Barton, G., Van Eigkelenborg, M., Barbe, C., Finnie, K., Kong, L., Ladouceur, F., McNiven, S., “Quantum Dot and Silica Nanoparticle Doped Polymer Optical Fibers.” Optics Express, 2007. 47: p. 9989-9994; Radojevic, V. N., Talijan, N., Trifunovic, D., Aleksic, R., “Optical fibers with composite magnetic coating for magnetic field sensing.” Journal of Magnetism and Magnetic Materials, 2004. 5: p. 272-276; Lu, X., Zhao, Y., Wang, C., “Fabrication of PbS nanoparticles in polymer-fiber matrices by electrospinning.” Advanced Materials, 2005. 17(20): p. 2485-2488; Bayindir, M., Abouraddy, A., Arnold, J., Joannopoulos, J., Fink, Y., “Thermal-Sensing Fiber Devices by Multimaterial Codrawing.” Advanced Materials, 2006. 18: p. 845-849; Garito, A. F., Hsiao, Y. L., Gao, R., “Thermal polymer nanocomposites”, U.P. Office, Editor. 2003; House, D. W., “Electrically conducting polymers,” U.P. Office, Editor. 1985; Dhawan, A., Seyam, A., Ghosh, T., Muth, J., “Woven fabric-based electrical circuits: Part 1: Evaluating interconnect methods.” Textile Research Journal., 2004. 74(10): p. 913-919; Boen, B., “Not-So-Heavy Metal: Electrical Conductivity in Textiles”, in NASA Spinoff. 2007; Coyle, S. W., Wu, Y., Lau, K. T., Brady, S., Wallace, G., Diamond, D., “Bio-sensing textiles—wearable chemical biosensors for health monitoring.” in 4th International Workshop on Wearable and Implantable Body Sensor Networks” 2007. Aachen University; Coyle, S., Chemical Sciences—Adaptive Sensors Group. 2007, www.dcu.ie/chemistry/asg/coyleshi; “Firewall Protection for Paper Documents”, in RFID Journal. 2007).

Fluorescence is conventionally applied to fibers using fluorescent dyes and coatings. Small fluorescent dye molecules can be placed in solution with dry polymer and solvent, which can then be spun into fibers. These dyes have the potential to leak in certain environments, and to lose their fluorescent strength during exposure to certain wavelengths of light (i.e. photobleaching). Common fluorescent dye molecules include Alq3, 10-(3-sulfopropyl), acridinium betaine, quinacrine dihydrochloride, naphthofluorescein, fluorescein, 8-hydroxypyrene-1, and 3, 6-trisulfonic acid trisodium salt (Yan, E., Wang, C., Huang, Z., Xin, S., Tong, Y., “Synthesis and Characterization of 1D Tris(8-Quinilinolato) Aluminum Fluorescent Fibers by Electrospinning.” Materials Science and Engineering, 2007. 464: p. 59-62; Moreda, G. F., Arregui, F. J., Achaerandio, M., Matias, I. R., “Study of Indicators for the Development of Fluorescence Based Optical Fiber Temperature Sensors.” Sensors and Actuators B: Chemical 2006. 118: p. 425-432). These dyes can easily provide fluorescence to polymer fibers, but they are not permanent, and their volatile nature within fibers can lead to certain health and environmental concerns. FIG. 1 illustrates a confocal microscopy image of such an electrospun CA fabric with 10 μL of fluorescent tetramethylrhodamine (TRITC) dye incorporated.

Therefore, though it is relatively simple to create fluorescent signal in fibers with fluorescent dyes, there is a need in the art for a method for better containing dyes in fibers if longer-term fluorescence is desired. There is also a need in the art for methods for creating long-term fluorescent signals in fibers.

Instead of fluorescent dyes, semiconductor quantum dots have been used in the past, but they are often composed of toxic heavy metals and their fluorescent signature is a function of particle size, meaning that particle size cannot be used as an identifier separate from color.

It is desirable not only to have absorption or emission as the unique identifiers, but rather to include particle architecture and composition. There is therefore a need in the art for creating unique signatures using particles of well-defined materials, composition and architecture. There is a further need for core-shell nanoparticle architectures, including those with multiple shells, having well-defined materials, architecture, compositions and properties.

Citation or identification of any reference in Section 2, or in any other section of this application, shall not be considered an admission that such reference is available as prior art to the present invention.

### 3. SUMMARY OF THE INVENTION

Fibers, fabrics and textiles in which core-shell silica nanoparticles are incorporated are provided. The fibers, fabrics and textiles can be polymeric materials or natural cellulose-based or protein-based materials in which core-shell silica nanoparticles are incorporated. A variety of polymeric and natural materials can be employed, such as cellulose acetate, nylon, rayon, modacrylic, olefin, acrylic, polyester, polylactic acid, polylactic-co-glycolic acid (PLGA), polyurethane, aramid, wool, cotton, ramie, milk protein, soy protein, bamboo, etc. The core-shell silica nanoparticles can incorporate sensing, magnetic, thermal, electrical, chemical or RFID properties that can be imparted to the materials and that allow the materials to sense one or more conditions of interest, making them ideal for in situ sensing, treatment (e.g., with drugs or pharmaceuticals), or security applications.

Core-shell silica-based nanoparticles (also referred to herein as core-shell silica nanoparticles) allow for a versatile toolbox. Core-shell silica nanoparticles can provide multifunctionality, as they allow incorporation of layers or cores made from, for example, silica, other oxides, metals, or organic materials (e.g., polymers), etc., thus providing well-defined particle architectures and compositions.

In one embodiment, a polymeric material is provided comprising a polymeric matrix material and core-shell silica nanoparticles, wherein:

the polymeric matrix material is selected from the group consisting of cellulose acetate, nylon, rayon, modacrylic, olefin, acrylic, polyester, polylactic acid, polylactic-co-glycolic acid (PLGA), polyurethane and aramid, and

the core-shell silica nanoparticles:

are attached to the polymeric material via covalent reaction between surface modification of the silica and the surface or within the matrix of the polymeric material, or

are mechanically entrapped within the polymeric material.

In one aspect of this embodiment, the nanoparticles are incorporated into the polymeric matrix material.

In another aspect of this embodiment, the core-shell silica nanoparticles have core diameters between 2 and 2000 nm and shell thicknesses between 1 and 2000 nm.

In another aspect, the polymeric material is in the form of a sheet, fiber, film, spray or bulk solid.

In another aspect, the polymeric matrix material or the core-shell silica nanoparticles have well-defined characteristics, such as size, shape, composition or architecture.

In another aspect, the polymeric material has a concentration of core-shell silica nanoparticles between 0.001 and 90 weight percent.

In another aspect, the polymeric material has a concentration of core-shell silica nanoparticles between 1 and 60 weight percent.

In another aspect, the core-shell silica nanoparticles are porous or have porous shells.

In another aspect, the core-shell silica nanoparticles comprise pharmaceutical, nutraceutical, veterinary, fragrance, anti-microbial, anti-clotting or clot-inducing, biologically active, RFID active or catalytic agents.

In another aspect, the core-shell silica nanoparticles contain a fluorescent dye or optical brightener that absorbs and emits between 200 and 1500 nm.

In another aspect, the core-shell silica nanoparticles comprise a fluorescent dye or an optical brightener that absorbs and emits between 200 and 1500 nm.

In another aspect, the core-shell silica nanoparticles comprise at least two types of dyes.

In another aspect, the at least two types of dyes are fluorescent dyes.

In another aspect, the core-shell silica nanoparticles comprise at least one sensor dye.

In another aspect, the core-shell silica nanoparticles further comprise a reference dye.

In another aspect, a single type of core-shell silica nanoparticle comprises the reference dye and the at least one sensor dye.

In another aspect, a single type of core-shell silica nanoparticle comprises a plurality of concentric shells. The concentric shells can be spherical or non-spherical.

In another aspect, the reference dye and the at least one sensor dye are disposed in different shells of the single type of core-shell silica nanoparticle.

In another aspect, the core-shell silica nanoparticles comprise:

a first type of core-shell silica nanoparticle wherein the internal structure of the first type of core-shell silica nanoparticle comprises the reference dye; and

one or more additional types of core-shell silica nanoparticle wherein the internal structure of the one or more additional types of core-shell silica nanoparticle comprises the at least one sensor dye.

In another aspect, the core-shell silica nanoparticles comprise a second type of core nanoparticle or shell material selected from the group consisting of magnetic, radio-active, tera-hertz active, plasmonically active, metal and metal oxide nanoparticles.

In another aspect, the polymeric material comprises a plurality of core-shell silica nanoparticle types, polymeric matrix types, or core-shell silica nanoparticle sizes.

In another aspect, the core-shell silica nanoparticles comprise a surface coating that is physically adsorbed or covalently bonded. The surface coating can be a small molecule (e.g., a linker molecule, a biologically active molecule) or can be a polymeric coating.

In another aspect, the core-shell silica nanoparticle comprises:

a core;

a plurality of shells comprising shell materials; and

an external surface comprising silica.

In another aspect, the shell materials are selected from the group consisting of silica (e.g., organically modified silica), metals, oxides, organic moieties (e.g., carbon- and hydrogen-based moieties such as polymers) and dyes.

In another embodiment, a natural material is provided comprising a natural cellulose-based or protein-based material and core-shell silica nanoparticles wherein:

the silica on the core-shell silica nanoparticles is surface-modified, and

the core-shell silica nanoparticles are attached to the natural material via covalent reaction between the surface modification of the silica and the surface of the natural cellulose-based or protein-based material.

In one aspect of this embodiment, the silica is surface-modified by treatment with maleimide, amine, succinimidyl ester, iodoacetamide, carboxyl or sulfonyl chloride.

In another aspect, the natural cellulose-based or protein-based material is selected from the group of cellulose-based materials consisting of cotton, linen, ramie and hemp or from the group of protein-based materials consisting of wool, silk, angora, cashmere, mohair and alpaca.

In another aspect, the core-shell silica nanoparticles have core diameters between 2 and 2000 nm and shell thicknesses between 1 and 2000 nm

In another aspect, the natural cellulose-based or protein-based material or the core-shell silica nanoparticles have well-defined characteristics, such as size, shape, composition or architecture.

In another aspect, the natural material has an add-on of core-shell silica nanoparticles between 0.001 and 50 weight percent.

In another aspect, the natural material has an add-on of core-shell silica nanoparticles between 0.01 and 5 weight percent.

In another aspect, the core-shell silica nanoparticles are porous or have porous shells.

In another aspect, the core-shell silica nanoparticles comprise pharmaceutical, nutraceutical, veterinary, fragrance, anti-microbial, anti-clotting or clot-inducing, biologically active, RFID active or catalytic agents.

In another aspect, the core-shell silica nanoparticles comprise a fluorescent dye or an optical brightener that absorbs and emits between 200 and 1500 nm.

In another aspect, the core-shell silica nanoparticles comprise at least two types of dyes.

In another aspect, the at least two types of dyes are fluorescent dyes.

In another aspect, the core-shell silica nanoparticles comprise at least one sensor dye.

In another aspect, the core-shell silica nanoparticles further comprise a reference dye.

In another aspect, a single type of core-shell silica nanoparticle comprises the reference dye and the at least one sensor dye.

In another aspect, the reference dye and the at least one sensor dye are disposed in different shells of the single type of core-shell silica nanoparticle.

In another aspect, the core-shell silica nanoparticles comprise:

a first type of core-shell silica nanoparticle wherein the internal structure of the first type of core-shell silica nanoparticle comprises the reference dye; and

one or more additional types of core-shell silica nanoparticle wherein the internal structure of the one or more additional types of core-shell silica nanoparticle comprises the at least one sensor dye.

In another aspect, the core-shell silica nanoparticles comprise a second type of core nanoparticle or shell material selected from the group consisting of magnetic, radio-active, tera-hertz active, plasmonically active, metal and metal oxide nanoparticles.

In another aspect, the natural material comprises a plurality of core-shell silica nanoparticle types, natural cellulose-based or protein-based material types, or core-shell silica nanoparticle sizes.

In another aspect, the core-shell silica nanoparticles comprise a surface coating that is physically adsorbed or covalently bonded. The surface coating can be a small molecule (e.g., a linker molecule, a biologically active molecule) or can be a polymeric coating.

In another aspect, the core-shell silica nanoparticle comprises:

a core;

a plurality of shells comprising shell materials; and

an external surface comprising silica.

In another aspect, the shell materials are selected from the group consisting of silica (e.g., organically modified silica), metals, oxides, organic moieties (e.g., carbon- and hydrogen-based moieties such as polymers) and dyes.

In another embodiment, a method for deterring counterfeiting of goods of interest is provided comprising tagging the goods with an anti-counterfeiting tag comprising a polymeric material or natural material of the invention comprising core-shell silica nanoparticles.

In another embodiment, a material is provided comprising:

at least one polymeric material selected from the group consisting of cellulose acetate, nylon, rayon, modacrylic, olefin, acrylic, polyester, polylactic acid, polylactic-co-glycolic acid (PLGA), polyurethane and aramid, or

at least one natural material selected from the group of cellulose-based materials consisting of cotton, linen, ramie and hemp or the group of protein-based materials consisting of wool, silk, angora, cashmere, mohair and alpaca, or

a blend or a mixture thereof; and

core-shell silica nanoparticles,

wherein the core-shell silica nanoparticles:

are attached to the polymeric or natural material via covalent reaction between surface modification of the silica and the surface of the polymeric or natural material or within the matrix of the polymeric material, or

are mechanically entrapped within the polymeric material.

In another embodiment, a method for deterring counterfeiting of goods of interest is provided comprising tagging the goods with an anti-counterfeiting tag comprising a polymeric material of the invention, a natural material of the invention, or a blend or a mixture thereof.

In one aspect, the polymeric material, the natural material or the core-shell silica nanoparticles have well-defined characteristics, such as size, shape, composition or architecture.

In another embodiment, a method for releasing a substance of interest in a desired location is provided comprising:

providing a material, wherein the material comprises:

a polymeric material, a natural cellulose-based or protein-based material, or a blend or a mixture thereof, and

core-shell silica nanoparticles, wherein, the core-shell silica nanoparticles comprise the substance of interest within the cores or within the shells; and

placing the material in the desired location, under release conditions whereby the substance of interest is released.

In one aspect, the substance of interest is a pharmaceutical, nutraceutical, veterinary, fragrance, anti-microbial, anti-clotting or clot-inducing, biologically active, RFID active or catalytic agent.

In another aspect, the core-shell silica nanoparticles are porous or have porous shells.

In another embodiment, a method for detecting a condition of interest in a subject is provided comprising:

providing a material, wherein the material comprises:

a polymeric material, a natural cellulose-based or protein-based material, or a blend or a mixture thereof, and

core-shell silica nanoparticles, wherein the core-shell silica nanoparticles are sensitive to the condition of interest;

contacting the subject with the material;

detecting change in the state of the sensitive core-shell silica nanoparticles indicative of the condition of interest; and

determining the condition of interest in the subject from the detected change.

In another embodiment, a method for monitoring sweat composition in a subject is provided comprising:

providing a material, wherein the material comprises:

a polymeric material, a natural cellulose-based or protein-based material, or a blend or a mixture thereof, and

pH-sensitive core-shell silica nanoparticles;

contacting the polymeric material with sweat produced by the subject;

detecting alteration in pH-sensitive properties of the pH-sensitive core-shell silica nanoparticles indicative of a pH change; and

calculating the pH of the sweat produced by the subject from the detected change.

### 4. BRIEF DESCRIPTION OF THE DRAWINGS

The present invention is described herein with reference to the accompanying drawings, in which similar reference characters denote similar elements throughout the several views. It is to be understood that in some instances, various aspects of the invention may be shown exaggerated or enlarged to facilitate an understanding of the invention.

FIG. 1 shows fluorescence and light microscope images of electrospun CA fabric with 10 μL of tetramethylrhodamine (TRITC) dye incorporated, where the scale bar represents 10 μm.

FIG. 2 shows structure of C dots with TRITC dye (Ow, H., Larson, D., Srivastava, M., Baird, B., Webb, W., Wiesner, U., “Bright and Stable Core-Shell Fluorescence Silica Nanoparticles.” Nano Letters, 2005. 5(1): p. 113-117).

FIG. 3 shows SEM images of C dot nanoparticles.

FIG. 4 shows TGA data for the electrospun samples X, Y and Z.

FIG. 5 shows TGA data for the dry spun samples X, Y and Z.

FIG. 6 shows CA fibers appear white under visible light. a) Control sample, b) Sample Z.

FIGS. 7a-7d show SEM images of a) control, b) X, c) Y, and d) Z electrospun samples with EBSD contrast. Scale bar represents 10 μm.

FIGS. 8a-8b show SEM images illustrating the large pores and variable fiber diameters for a) control and b) Z samples of CA dry spun fibers between the arrows. Scale bar represents 200 μm.

FIGS. 9a-9d show light microscope (left column) and fluorescence (right column) images of a) control, b) X, c) Y, and d) Z samples of CA electrospun fabrics. Scale bar represents 10 μm.

FIGS. 10a-10d shows light microscope (left column) and fluorescence (right column) images of a) control, b) X, c) Y, and d) Z samples of CA dry spun fabrics. Scale bar represents 10 μm.

FIGS. 11a-11c are bar graphs illustrating the a) average moduli, b) average tensile stress at break, and c) average tensile strain at break for electrospun CA fibers.

FIGS. 12a-12c are bar graphs illustrating the a) average moduli, b) average tensile stress at break, and c) average tensile strain at break for dry spun CA fibers.

FIG. 13 is a diagram showing that fibers comprising different types of core-shell silica nanoparticles with different functionalities can be combined within a single yarn. In this example, fibers containing two types of core-shell silica nanoparticles (Cdot1, Cdot2) are combined in a yarn.

FIG. 14 is a diagram showing yarns containing four types of core-shell silica nanoparticles (Cdot1, Cdot2, Cdot3, Cdot4) further combined in a woven fabric.

FIG. 15 shows the relationship between fluorescence intensity (y-axis, FITC/TRITC, C_{avg}) and pH (x-axis) for electrospun fabrics containing pH-sensor core-shell silica nanoparticles. Slope of the graphed line: y=0.0364x+1.0941. Pairs of photographs show FITC fluorescence (left) and TRITC fluorescence (right) images of fibers at two different magnitude of pH. At higher pH, FITC fluorescence from the pH-sensor core-shell silica nanoparticles is greater. Scale bars 5 μm.

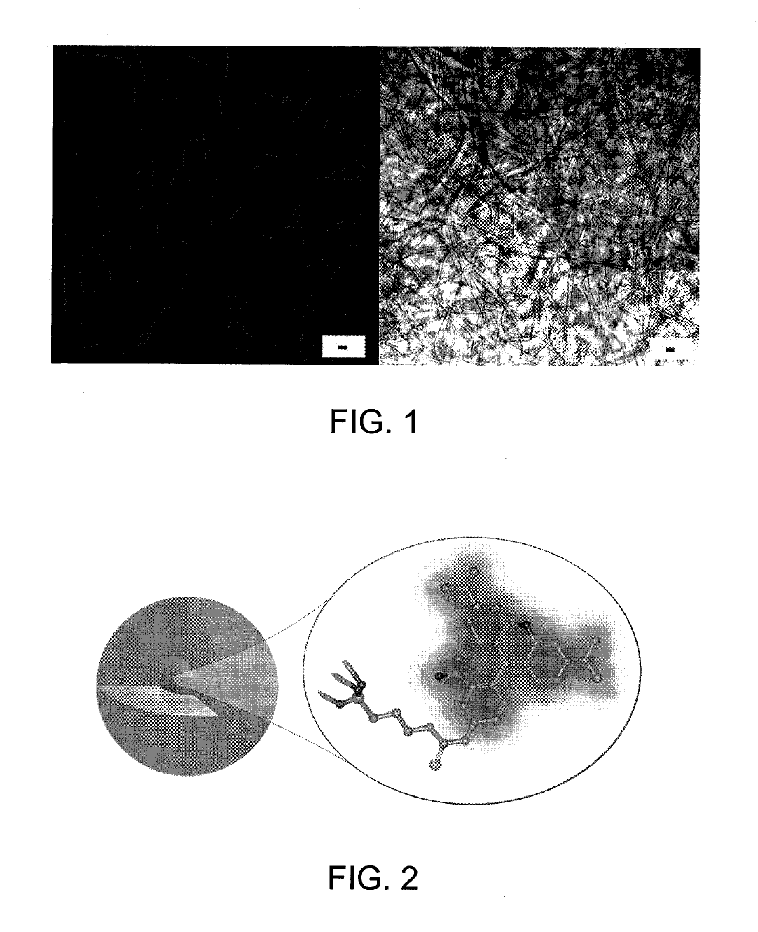

### 5. DETAILED DESCRIPTION OF THE INVENTION

For clarity of disclosure, and not by way of limitation, the detailed description of the invention is divided into the subsections set forth below.

### 5.1 Core-Shell Silica Nanoparticles

The invention provides fibers, fabrics and textiles in which core-shell silica nanoparticles are incorporated. The core-shell silica nanoparticles can incorporate sensing, magnetic, thermal, electrical, chemical or RFID properties that can be imparted to the fiber as well and that allow the fibers to sense one or more conditions of interest, making them ideal for in situ sensing, treatment (e.g., with drugs or pharmaceuticals), or security applications.

Methods for making core-shell silica nanoparticles are known in the art. For example, Cornell dots (“C dots” or “Cdots”) can be used. C dots can be made using art-known methods (Ow, H., Larson, D., Srivastava, M., Baird, B., Webb, W., Wiesner, U., “Bright and Stable Core-Shell Fluorescence Silica Nanoparticles.” Nano Letters, 2005. 5(1): p. 113-117; Larson, D. R., Ow, H., Vishwasrao, H. D., Heikal, A. A., Wiesner, U., Webb, W. W. “Silica nanoparticle architecture determines radiative properties of encapsulated fluorophores.” Chemistry of Material, 2008. 20(8): 2677-2684; U.S. Patent Application 20040101822A1, entitled “Fluorescent silica-based nanoparticles,” by Wiesner et al., May 27, 2004; U.S. Patent Applications 20060183246A1 entitled “Fluorescent silica-based nanoparticles,” by Wiesner et al., Aug. 17, 2006).

In one embodiment, fluorescent core-shell silica nanoparticles can be incorporated into fibers. The fluorescing silica nanoparticles can comprise, e.g., a fluorescent dye-containing silica core surrounded by a silica shell. Such fluorescing core-shell silica nanoparticles are known in the art (U.S. Patent Application 20040101822A1, entitled “Fluorescent silica-based nanoparticles,” by Wiesner et al., May 27, 2004; U.S. Patent Application 20060183246A1 entitled “Fluorescent silica-based nanoparticles,” by Wiesner et al., Aug. 17, 2006).

Fluorescent C dot nanoparticles can comprise, for example, a core comprising a fluorescent silane compound and a silica shell on the core. The fluorescent C dot nanoparticles can include fluorescent nanoparticles, ligated-fluorescent nanoparticles, ligated-fluorescent nanoparticles comprising therapeutic agents, and ligated-fluorescent nanoparticles coupled or associated with an analyte. Ligated-fluorescent nanoparticles can be associated with a cellular component of interest.

In one embodiment, fluorescent C dot nanoparticles are composed of a 2.2 nm fluorescent dye core surrounded by a silica shell that exhibits color when excited by an external light source at a specific wavelength. Fluorescent C dots with 20-30 nm diameters can be 20-30 times brighter than single fluorescent dye molecules, and exhibit greater resistance to photo bleaching (Ow, H., et al., Bright and Stable Core-Shell Fluorescent Silica Nanoparticles. Nano Letters, 2005. 5: p. 113-117). The silica shell allows the particles to maintain brightness for longer than a fluorescent solution.

C dot nanoparticles can be dispersed in several different solvents, including water and acetone, without degradation. To disperse the C dots in a non-polar solvent, such as benzene or diethyl ether, surface modification of the nanoparticles is required. The only solvents that the C dots cannot be dispersed in are strong acids and bases, which dissolve the silica shell. Additionally, these nanoparticles can resist degradation at temperatures up to 150° C. At temperatures greater than 150° C. the fluorescent dye begins to degrade.

Core-shell silica nanoparticles provide an excellent and stable matrix to protect the organic dyes from future processing, heat, and light. The covalently bound dyes do not leach out of the silica nanoparticle and hence will not leach out of the polymeric materials that incorporate such nanoparticles. Furthermore, such particles present a uniform silica surface that does not change as a function of the dye that is incorporated. Hence, for processing of different colors/dyes, the same manufacturing process can be employed. When magnetic, sensing, or chemically active materials are incorporated, the surface remains silica, again retaining the well known properties and performance of silica. The core-shell silica nanoparticles, with controllable sizes that can be varied from 3 nm to several microns in diameter, allow unique identification of the fibers in which they are incorporated.

By encapsulating a material of interest within a silica shell in a core-shell configuration, the resulting surface of the nanoparticle is homogeneous. Such a surface homogenization allows for a single integration step in the processing of the polymer, while allowing for a multitude of functionalities to be added upon encapsulation.

Because each dye molecule, fragrance, antimicrobial, pharmaceutical, nutraceutical, metal or metal oxide particle to be introduced interacts differently with the polymer matrix of the fiber or film, processing is preferably optimized for each type of additive individually using methods known in the art. By encapsulating these materials within a silica shell or a porous silica material, the fiber or film processing is optimized only once and does not need to be re-optimized when other additives are incorporated into the particle. Such core-shell particles are physically entrapped within polymeric fibers or films. Through proper surface functionalization, the particles can also be covalently attached throughout the polymeric matrix, either within the fiber/film or on the surface.

In a specific embodiment, 30 nm TRITC core-shell silica particles can be synthesized as follows:

100 microliters of tetramethylrhodamine dye dissolved in dimethylsulfoxide are conjugated to a concentration of 4.5 mM, with a 50× molar excess of 3-aminopropyltrimethoxysilane. The reaction is allowed to proceed overnight under nitrogen.

21.2 mL ethanol (200 Proof), 386 uL deionized water, and 2.58 mL 2M ammonia in ethanol are added to a round bottom flask. Mixing is started (using, e.g., a magnetic stir bar) and 100 μL of dye conjugate is added. After the dye has been well dispersed in the solution, 287 uL tetraethylorthosilicate (TEOS) is added. The core formation reaction is stirred for 8 hours.

After the 8 hour core reaction, a shell of pure TEOS is added to the desired thickness. For 30 nm TRITC particles, 25 uL TEOS are added every 15 minutes 23 times.

Particles are cleaned by dialysis into water or other desired polar solvent.

In another specific embodiment, 180 nm TRITC core-shell silica particles can be synthesized as follows:

For a 200 mL reaction, 1.2 mL TRITC (4.5 mM concentration) is mixed with a 50× molar excess of 3-aminopropyltrimethoxysilane. The reaction is allowed to proceed under a nitrogen atmosphere overnight.

173.7 mL ethanol, 17.4 mL ammonium hydroxide and 8.9 mL TEOS are added to a round bottom flask, mixed well and 1.2 mL of TRITC conjugate is added. The mixture is allowed to react 12 hours.

A pure TEOS shell is added to the desired thickness or overall particle size. To avoid secondary nucleation, only 1 μL TEOS is added per mL of reaction size per 15 minutes.

Particles are cleaned by centrifugation into the desired solvent.

In another embodiment, photoluminescent silica-based particles (U.S. Patent Application 20060245971A1, Burns et al., published Nov. 2, 2006) can be incorporated into fibers. The particles can comprise a silica-based core and at least one photoluminescent dye. The silica-based core of the particle may comprise a plurality of pores and the at least one photoluminescent dye may comprise a reference dye, insensitive to its environment and analytes and a sensor dye, sensitive to either or both of the foregoing. The reference dye is a dye that is substantially insensitive to its environment and/or any analytes present therein or exhibits the same or substantially the same photon emissions upon exposure to excitation photons in different environments. The sensor dye is any dye that is sensitive or responsive to its environment and/or analytes or exhibits different photon emissions upon exposure to photons in different environments or analytes. In certain embodiments, the reference and sensor dyes may be covalently bound to the silica-based matrix. In other embodiments, the dyes may be incorporated into the silica-based matrix through physical entrapment without covalent linkages or adsorbed onto the surface of the matrix. The particles may be employed as sensors to sense unknown environmental conditions or analytes in biological or non-biological systems, in vitro or in vivo, for example, pH, metal status (concentration), redox status, oxygen concentration, or peroxide concentration.

Many fluorescent or photoluminescent dyes known in the art can be incorporated into C dots such as TRITC, cyanine based dyes such as Cy3, Cy5, Cy5.5, Cy7, Cy7.5, DY730, DY731, DY732, DY734, DY780 and others such as Alexa Fluor 700, Alexa Fluor 750, Oregon Green 488, Oregon Green 514, diethylaminocoumarin (DEAC), fluorescein, tetramethylrhodaminemaleimide, and Texas Red.

Suitable reference dyes include, but are not limited to, the dyes listed in paragraph [0032] of U.S. Patent Application 20060245971A1 and also listed below: Molecular Probes AlexaFluor 350, Molecular Probes Pacific Blue, Molecular Probes AlexaFluor 488, Molecular Probes AlexaFluor 532, Rhodamine B, Isothiocyanate, Tetramethylrhodamine isothiocyanate, Molecular Probes AlexaFluor 568, Dyomics DY 610, Dyomics DY 615, Molecular Probes AlexaFluor 647, Dyomics DY 675, Dyomics DY 700, Dyomics DY 731, Dyomics DY 776, Sigma Aldrich NIR 797, Dyomics DY 485 XL (Mega-Stokes™ emission), Dyomics DY 510 XL (Mega-Stokes™ emission). MEGASTOKES™ dyes are dyes that exhibit Stokes shifts between their excitation and emission wavelengths between about 30.0 nm to about 200.0 nm.

Other dyes suitable for use in the invention are known in the art and can be readily determined by the skilled artisan by consulting, e.g., Richard Hauglund, The Handbook: A guide to flourescent probes and labeling techniques, 10th ed. 2005, Invitrogen Corp. (http://www.invitrogen.com/site/us/en/home/References/Molecular-Probes-The-Handbook.html).

The sensor dye is typically placed at or near a surface of the silica-based particle to increase its interaction with the environment and/or any analytes. Under this construction, the sensor dye is more likely to come into direct contact with the environmental condition or analyte undergoing investigation. Emissions of sensor dyes are subject to environmental or analyte stimuli. Depending on pH of the environment, pH sensor dyes, for example, exhibit varying emission spectra based on changes in the sensor dye's electronic state, through the addition or subtraction of protons. The presence of metal ions may cause diminished emissions by quenching the sensor dye.

Suitable sensor dyes include, but are not limited to, the dyes listed in paragraph [0034] of U.S. Patent Application 20060245971A1 and also listed below: Fluorescein Isothiocyanate, B-5-carboxyfluorescein-bis-(5-carboxymethoxy-2-nitrobenzyl), ether-alanine-carboxamide, succinimidyl ester, Fluo-4 Iodoacetamide, 5-carboxy-2′,7′-dichlorosulfonefluorescein, Carboxy Seminaphthofluorescein (SNAFL-1) NHS ester, Oregon Green 514 Carboxylic Acid NHS ester, Erythrosin B Isothiocyanate, Sigma Aldrich NIR667-NHS, Fluorescein, Fluo-4, Calcium Green, 2′,7′-bis-(2-carboxyethyl)-(5/6)-carboxyfluorescein, Seminapthorhodafluor-1 (SNARF-1), 4′,5′-dichloro-2′,7′-dimethoxyfluorescein, X-Rhod, PBFI (spectral shift), 6-methoxy-N-(3-sulfopropyl)quinolinium), Zinquin Ethyl Ester, Diaminonapthalene, Calcium Yellow, 4,5-Diaminofluorescein, 4-amino-5-methylamino-2′,7′-difluorofluorescein, Calcium Green, Magnesium Green, Dihydrorhodamine, Calcium Orange, CoroNa Red, RhodZin-3, Resorufin ethers (benzyl, ethyl, methyl, etc.), Sulforhodamineamidoethyl mercaptan, and Boron dipyrromethane (BODIPY 665-676).

Caged dyes may be employed as the sensor dye. Caged dyes are a class of photoluminescent dyes whose photoluminescent state is activated by their environment. In other words, caged dyes enter their working environment in a non-photoluminescent state and are turned “on” by external events that modify the chemical structure of the dye. Caged dyes typically comprise a covalent attachment of particular groups to a main conjugated ring structure. Activation may occur when the covalent attachment is cleaved due to environmental stimuli. For example, resorufin (7-hydroxy-3H-phnoxazin-3-one) is the parent dye of a family of caged dyes that utilize a cleavable ether attachment.

In another embodiment, core-shell silica nanoparticles incorporating radio frequency identification (RFID) tags can be used. RFID tags are commonly applied to many products for identification using radio waves. In one embodiment, fibers comprising silica nanoparticles incorporating RFID tags reflect a portion of the RFID reader's signal. The RFID reader then returns a unique signal as an identifier. These fibers can be thin threads or fine wires, and can be applied to a container or garment in the same manner as traditional RFID tags.

In another specific embodiment, mesoporous magnetic nanoparticles can be incorporated in the polymeric material. Mesoporous magnetic nanoparticles can be synthesized as follows:

Chemical reagents hexadecyltrimethylammonium bromide (appx. 99%), ethyl acetate (ACS grade), tetraethyl silane (TEOS) (≧99%, GC), ammonium hydroxide (29%), acetic acid (gracial), hydrochloric acid (36.5-38%), ethanol (absolute, anhydrous), deionized water (Milli-Q, 18.2 Macm), chloroform (AR grade), 1-octadecene (AR grade), iron (III) oxide (FeO(OH)) (hydrated, 30-50 mesh), oleic acid (technical grade, 90%), acetone (AR grade) are used without purification.

8-9 nm iron oxide nanoparticles are synthesized using methods known in the art (William W. Yu, J. C. F., Cafer T. Yavuz and Vicki L. Colvin (2004). “Synthesis of monodisperse iron oxide nanocrystal by thermal decomposition of iron carboxylate salts.” Chem. Commun.: 2306-2307). FeO(OH) (0.356 g) are mixed together with oleic acid (4.52 g) and 1-octadecene (10 mL) in three-necked flask. While stirring, nitrogen gas is purged through the mixture around 10 min before heating to 320° C. for 1 hr. After cooled to room temperature, the as-made nanoparticles are cleaned by the addition of acetone and separated by centrifugation. The spun particles are re-dispersed back in hexane and washing step was repeated 2 more times. The particles are suspended in chloroform for the next step.

To accomplish phase transfer of magnetic particles to aqueous, 15 mg of magnetic nanoparticles in 0.5 mL of chloroform is added to 5 mL of CTAB solution (54.8 mM). The mixture is stirred until homogeneous microemulsion was formed. Then, the solution is transferred to the pre-heated oil bath at 70° C. for 10 min to evaporate off chloroform as well as to induce the interaction between hydrophobic chains of the two surfactants.

To synthesize mesoporous silica nanoparticles incorporating magnetic nanoparticles, the 0.5 mL of as-made CTAB-stabilized magnetic nanoparticles are diluted in 10 mL of water. 0.88 mL of ethyl acetate is next added in solution under stirring. 5 minutes after the addition of 0.27 mL of NH₄OH and 50 mL of TEOS, 3.69 mL of water is added into the reaction and allowed to proceed for another 10 minutes. An aliquot is taken from the reaction mixture every 1 minute and neutralized by adding 2 M HCl. The resulting material is cleaned by centrifugation using water and ethanol. To remove the surfactant templates, in the last washing, particles are redispersed in ethanol to prepare acetic acid-ethanol solution. Centrifugation in water and ethanol is employed in a cleaning step (Sajanikumari Sadasivan, C. E. F., Deepa Khushalani, and Stephen Mann (2002). “Nucleation of MCM-41 nanoparticles by internal reorganization of disordered and nematic-like silica-surfactant clusters.” Angew. Chem. 114: 2255-2257).

In another embodiment, superparamagnetic nanoparticles can be incorporated into fibers. Methods for producing superparamagnetic nanoparticles are well known in the art. For example, the methods of U.S. Pat. No. 6,645,626 (entitled “Superparamagnetic nanostructured materials,” Garcia et al., issued Nov. 11, 2003) can be used. To produce superparamagnetic nanoparticles, amphiphilic block copolymers are used as structure-directing agents. A block copolymer solution containing an amphiphilic block copolymer is formed. A sol-gel precursor is formed by hydrolyzing and condensing a silicate precursor solution. An iron precursor is added to either the block copolymer solution or the sol-gel precursor. The sol-gel precursor is mixed with the block copolymer solution to form a hybrid inorganic nanostructured material. Solvent is then removed resulting in the formation of individual nanostructured material which is calcinated to form the superparamagnetic nanostructured material. The resulting superparamagnetic nanostructured material may be in the shape of a sphere, a cylinder, lamellae, or a mesoporous structure.

In another embodiment, the core-shell silica nanoparticles can have electrically conductive properties. Fibers incorporating such nanoparticles can carry electrical signals, while non-conducting fibers can be distributed among the conducting fibers to act as space-holders between the conducting fibers. Such a fiber or fabric assembly (“electro-textile”) can be attached, for example, to an electrical circuit, creating a fabric that can sense, actuate, communicate, and/or compute.

In another embodiment, the core-shell silica nanoparticle can comprise a chemical sensing component that can be used, e.g., in various fabrics to monitor the wearer's health and environment. The active surface of the chemical sensor can interact with a feature of the external environment.

In a specific embodiment, the core-shell silica nanoparticle can comprise a pH sensing component.

In another embodiment, the core-shell silica nanoparticles can possess thermal or thermosensing properties.

In another embodiment, core shell silica nanoparticles having multiple shells can be incorporated into the fibers. These multi-shell particles can comprise a core and different shells comprising different materials, such as silica (e.g., organically modified silica), metals, oxides, organic moieties (e.g., carbon- and hydrogen-based moieties such as polymers) and dyes, so that the final multi-shell particle provides a unique chemical and/or signal fingerprint. Typically, the geometry can take the form of concentric shells. The concentric shells can be spherical or non-spherical. The final (external) shell in the series can be silica, to provide a uniform, well known, surface for processing into the fibers. In this way, a fixed ratio of materials may be introduced into the fibers. This approach has advantages over simply mixing the same materials in different particles into the fibers. In the latter case, the correlation of concentration in the feed of materials and concentration of the materials in the finished fibers may not be the same and is, thus, difficult to control. Hence, by using individual particles comprising the desired materials in known ratios, this difficulty is overcome.

### 5.2 Materials Incorporating Core-Shell Silica Nanoparticles

Many polymeric materials known in the art are suitable for use in the methods and compositions of the invention.

In one embodiment, a polymeric material is provided comprising a polymeric matrix material and core-shell silica nanoparticles, wherein the polymeric matrix material is selected from the group consisting of cellulose acetate, nylon, rayon, modacrylic, olefin, acrylic, polyester, polylactic acid, polylactic-co-glycolic acid (PLGA), polyurethane and aramid. Methods for making these polymeric materials are well known in the art.

Film forms, bulk forms, spray or powder forms of the polymer/core-shell silica nanoparticle material can also be produced using methods well known in the art.

Pre-polymeric mixtures can also be produced. In such mixtures, a monomer of one or more polymers is mixed with core-shell silica nanoparticles along with an initiator that forms a fiber, film, or bulk form when polymerized by heat, light, or some other external activation energy or source.

In one embodiment, a polymeric material is provided comprising a polymeric matrix material and core-shell silica nanoparticles, wherein:

the polymeric matrix material is selected from the group consisting of cellulose acetate, nylon, rayon, modacrylic, olefin, acrylic, polyester, polylactic acid, polylactic-co-glycolic acid (PLGA), polyurethane and aramid, and

the core-shell silica nanoparticles:

are attached to the polymeric material via covalent reaction between surface modification of the silica and the surface or within the matrix of the polymeric material, or

are mechanically entrapped within the polymeric material.

In one aspect of this embodiment, the core-shell silica nanoparticles have core diameters between 2 and 2000 nm and shell thicknesses between 1 and 2000 nm.

In another aspect, the polymeric material is in the form of a sheet, fiber, film, spray or bulk solid. In certain embodiments, the fiber can be a multi-component fiber, which is well known in the art, e.g., bicomponent, coaxial, islands-in-the-sea, etc.

In another aspect, the polymeric material has a concentration of core-shell silica nanoparticles between 0.001 and 90 weight percent.

In another aspect, the polymeric material has a concentration of core-shell silica nanoparticles between 1 and 60 weight percent.

In another aspect, the core-shell silica nanoparticles are porous or have porous shells.

In another aspect, the core-shell silica nanoparticles comprise pharmaceutical, nutraceutical, veterinary, fragrance, anti-microbial, anti-clotting or clot-inducing, biologically active, RFID active or catalytic agents.

In another aspect, the core-shell silica nanoparticles contain a fluorescent dye or optical brightener that absorbs and emits between 200 and 1500 nm.

In another aspect, the core-shell silica nanoparticles comprise a fluorescent dye or an optical brightener that absorbs and emits between 200 and 1500 nm.

In another aspect, the core-shell silica nanoparticles comprise at least two types of dyes.

In another aspect, the at least two types of dyes are fluorescent dyes.

In another aspect, the core-shell silica nanoparticles comprise at least one sensor dye.

In another aspect, the core-shell silica nanoparticles further comprise a reference dye.

In another aspect, a single type of core-shell silica nanoparticle comprises the reference dye and the at least one sensor dye.

In another aspect, the reference dye and the at least one sensor dye are disposed in different shells of the single type of core-shell silica nanoparticle.

In another aspect, the core-shell silica nanoparticles comprise:

a first type of core-shell silica nanoparticle wherein the internal structure of the first type of core-shell silica nanoparticle comprises the reference dye; and

one or more additional types of core-shell silica nanoparticle wherein the internal structure of the one or more additional types of core-shell silica nanoparticle comprises the at least one sensor dye.

In another aspect, the core-shell silica nanoparticles comprise a second type of core nanoparticle or shell material selected from the group consisting of magnetic, radio-active, tera-hertz active, plasmonically active, metal and metal oxide nanoparticles.

In another aspect, the polymeric material comprises a plurality of core-shell silica nanoparticle types, polymeric matrix types, or core-shell silica nanoparticle sizes.

In another aspect, the core-shell silica nanoparticles comprise a surface coating that is physically adsorbed or covalently bonded. The surface coating can be a small molecule (e.g., a linker molecule, a biologically active molecule) or can be a polymeric coating.

In another aspect, the core-shell silica nanoparticle comprises:

a core;

a plurality of shells comprising shell materials; and

an external surface comprising silica.

In another aspect, the shell materials are selected from the group consisting of silica (e.g., organically modified silica), metals, oxides, organic moieties (e.g., carbon- and hydrogen-based moieties such as polymers) and dyes.

In another embodiment, a natural material is provided comprising a natural cellulose-based or protein-based material and core-shell silica nanoparticles wherein:

the silica on the core-shell silica nanoparticles is surface-modified, and

the core-shell silica nanoparticles are attached to the natural material via covalent reaction between the surface modification of the silica and the surface of the natural material.

In one aspect of this embodiment, the silica is surface-modified by treatment with maleimide, amine, succinimidyl ester, iodoacetamide, carboxyl or sulfonyl chloride.

In another aspect, the natural cellulose-based or protein-based material is selected from the group of cellulose-based materials consisting of cotton, linen, rami and hemp or from the group of protein-based materials consisting of wool, silk, angora, cashmere, mohair and alpaca.

In another aspect, the core-shell silica nanoparticles have core diameters between 2 and 2000 nm and shell thicknesses between 1 and 2000 nm

In another aspect, the natural material has an add-on of core-shell silica nanoparticles between 0.001 and 50 weight percent.

In another aspect, the natural material has an add-on of core-shell silica nanoparticles between 0.01 and 5 weight percent.

In another aspect, the core-shell silica nanoparticles are porous or have porous shells.

In another aspect, the core-shell silica nanoparticles comprise pharmaceutical, nutraceutical, veterinary, fragrance, anti-microbial, anti-clotting or clot-inducing, biologically active, RFID active or catalytic agents.

In another aspect, the core-shell silica nanoparticles comprise a fluorescent dye or an optical brightener that absorbs and emits between 200 and 1500 nm.

In another aspect, the core-shell silica nanoparticles comprise at least two types of dyes.

In another aspect, the at least two types of dyes are fluorescent dyes.

In another aspect, the core-shell silica nanoparticles comprise at least one sensor dye.

In another aspect, the core-shell silica nanoparticles further comprise a reference dye.

In another aspect, a single type of core-shell silica nanoparticle comprises the reference dye and the at least one sensor dye.

In another aspect, the reference dye and the at least one sensor dye are disposed in different shells of the single type of core-shell silica nanoparticle.

In another aspect, the core-shell silica nanoparticles comprise:

a first type of core-shell silica nanoparticle wherein the internal structure of the first type of core-shell silica nanoparticle comprises the reference dye; and

one or more additional types of core-shell silica nanoparticle wherein the internal structure of the one or more additional types of core-shell silica nanoparticle comprises the at least one sensor dye.

In another aspect, the core-shell silica nanoparticles comprise a second type of core nanoparticle or shell material selected from the group consisting of magnetic, radio-active, tera-hertz active, plasmonically active, metal and metal oxide nanoparticles.

In another aspect, the natural material comprises a plurality of core-shell silica nanoparticle types, natural cellulose-based or protein-based material types, or core-shell silica nanoparticle sizes.

In another aspect, the core-shell silica nanoparticles comprise a surface coating that is physically adsorbed or covalently bonded. The surface coating can be a small molecule (e.g., a linker molecule, a biologically active molecule) or can be a polymeric coating.

In another aspect, the core-shell silica nanoparticle comprises:

a core;

a plurality of shells comprising shell materials; and

an external surface comprising silica.

In another aspect, the shell materials are selected from the group consisting of silica (e.g., organically modified silica), metals, oxides, organic moieties (e.g., carbon- and hydrogen-based moieties such as polymers) and dyes.

Materials provided by the invention can also be blends or mixtures of polymeric materials and/or natural materials of the invention. In another embodiment, a material is provided comprising:

at least one polymeric material selected from the group consisting of cellulose acetate, nylon, rayon, modacrylic, olefin, acrylic, polyester, polylactic acid, polylactic-co-glycolic acid (PLGA), polyurethane and aramid, or

at least one natural material selected from the group of cellulose-based materials consisting of cotton, linen, ramie and hemp or the group of protein-based materials consisting of wool, silk, angora, cashmere, mohair and alpaca, or

a blend or a mixture thereof; and

core-shell silica nanoparticles,

wherein the core-shell silica nanoparticles:

are attached to the polymeric or natural material via covalent reaction between surface modification of the silica and the surface of the polymeric or natural material or within the matrix of the polymeric material, or

are mechanically entrapped within the polymeric material.

### 5.3 Methods for Incorporating Core-Shell Silica Nanoparticles into Materials

The invention provides methods for incorporating core-shell silica nanoparticles into fibers during a fiber spinning process. Core-shell silica nanoparticles can be incorporated into fibers spun by art-known fiber manufacturing methods such as electrospinning wet spinning, dry spinning, dry-jet wet spinning, melt spinning or gel spinning. Electrostatic fiber spinning or ‘electrospinning’ is an art-known method for forming fibers with submicron scale diameters through electrostatic forces. When an electrical force is applied at the interface of a liquid polymer, a charged jet is ejected. The jet initially extends in a straight line, then moves into a whipping motion caused by the electro-hydrodynamic instability at the tip. As the solvent evaporates, the polymer is collected, e.g. onto a grounded piece of aluminum foil as a nonwoven mat (Kim, C. K., D S. Kim, S Y. Kang, M Marquez, and Y L. Joo, “Structural Studies of Electrospun Cellulose Nanofibers.” Polymer, 2006. 47(14): p. 5097-5107).

Dry spinning is an art-known technique commonly used to spin cellulose acetate fibers, and is a common industrial spinning method. The dope solution is composed of a cellulose acetate-acetone mixture containing approximately 15-30 wt % polymer. The dope solution is extruded from a spinneret, and the solution is drawn down to a roller at the bottom of the spinning column (Sano, Y., “Drying Behavior of Acetate Filament in Dry Spinning.” Drying Technology, 2001. 19(7): p. 1335-1359).

Preparation of electrospun and dry spun solutions can be carried out using methods known in the art.

In one embodiment, electrospun fabrics can be manufactured using low molecular weight cellulose acetate (CA) (M_{w}=30,000). In another embodiment, dry spun fibers can be formed with a high molecular weight CA (M_{w}=50,000). In both cases, CA can be dissolved in a 3:1 v/v acetone: water solution. The core-shell silica nanoparticles (Cdots) can be suspended in acetone, and added to the CA solutions. The solutions of cellulose acetate, acetone, water and C dots can be mixed, e.g., on platform shaker, prior to fiber formation.

In another embodiment, core-shell silica nanoparticles can be applied to the surfaces of natural cellulose-based (e.g., cotton, linen, ramie, bamboo, soy, hemp, etc.) or protein-based (wool, silk, angora, cashmere, alpaca, etc.) already-spun fibers or fabrics. Cellulosic fiber surfaces contain many available hydroxyl groups for reaction with functionalized core-shell silica nanoparticles. Protein fiber surfaces also contain amide, peptide and carboxylic acid groups available for reaction with core-shell silica nanoparticles. Silica surfaces of core-shell silica nanoparticles can be functionalized with silane, methylol or amine groups. For example, functionalized core-shell silica nanoparticles can be applied to a cellulose-based or protein-based fabric by suspending the core-shell silica nanoparticles in water and padding this suspension onto the fabric. The fabric is then dried (e.g., at 120° C. for cotton) and cured in hot air (e.g., for 3 minutes at 160° C. for cotton). Drying and curing times can be readily determined by the skilled practitioner.

Analyses known in the art can be performed to determine the incorporation of particles into fibers, such as thermogravimetric analysis, confocal microscopy, scanning electron microscopy, and mechanical testing (e.g., to ASTM standards).

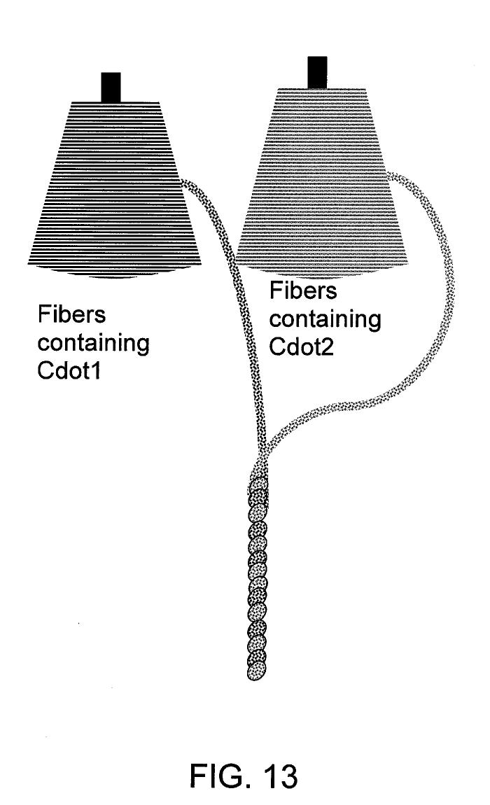

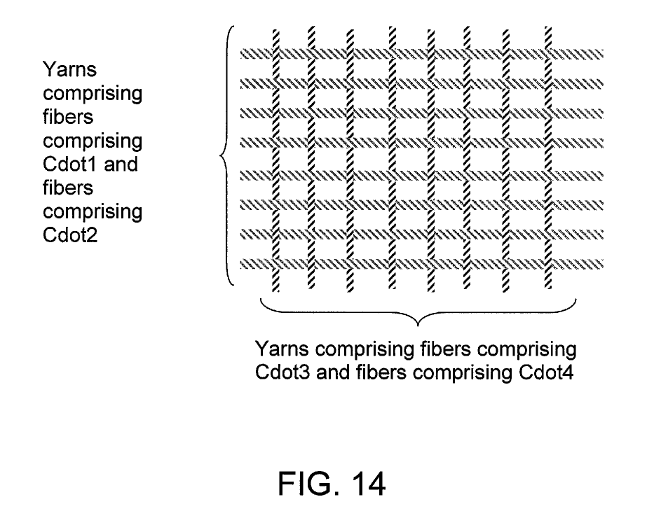

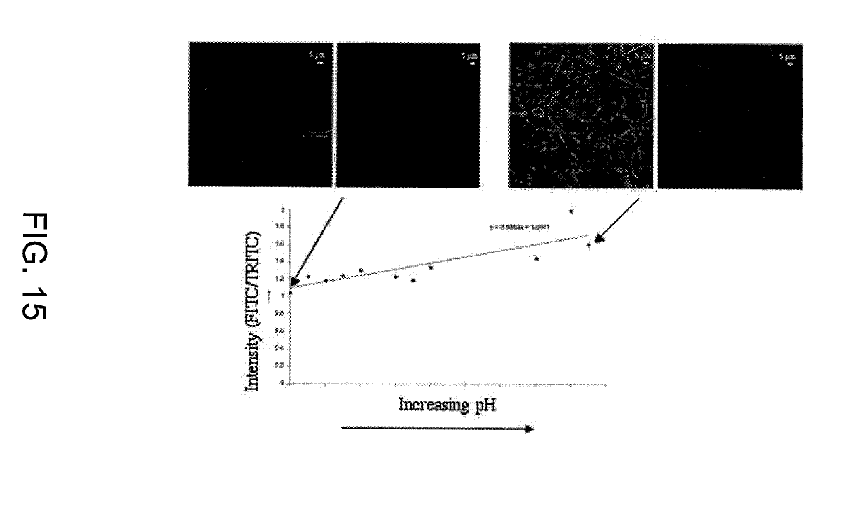

Fibers that contain core-shell silica nanoparticles that are prepared by any art-known fiber manufacturing methods (e.g., electrospinning, wet spinning, dry spinning, dry-jet wet spinning, melt spinning, gel spinning) can be combined to form single yarns (FIG. 13), plied yarns, woven fabrics (FIG. 14), knit fabrics or nonwoven fabrics. Fibers comprising different types of core-shell silica nanoparticles with different functionalities can be combined within a single yarn or fabric structure.

### 5.4 Uses

Core-shell silica nanoparticles incorporated in fibers can be used for tagging, sensing and signaling applications. Particles may be produced with a silica shell by employing surface homogenization, and then incorporated into a polymeric matrix. By incorporating multiple dyes (fluorescent or absorbing) within a core-shell silica nanoparticle, a multiplexed particle can be designed to have a specific spectral fingerprint. Each dye (or other sensing material) can be contained within a separate silica shell, thereby producing different functionalities in different shells. Furthermore, multiple modality fingerprints for high security applications can be designed by using magnetic, fluorescent, electrical, chemical, etc. signals in a single particle, together with the specific size, shape, composition or architecture of the particles.

Using methods known in the art, sensing particles can be designed using a two-dye system wherein the core dye is a reference dye and the sensor dye is in the shell or on the surface for maximized interaction with the environment (see, e.g., Burns, A., et al., Core/Shell Fluorescent Silica Nanoparticles for Chemical Sensing: Towards Single-Particle Laboratories. Small, 2006. 2(6): p. 723-726). Such an internally referenced system is useful for calibrating detectors and, again, can be produced in a multi-modal format. Certain metal or metal-oxide cores or shells can also be incorporated into the silica particles to act as color centers or enhance the fluorescence of the particles through plasmonic activity or otherwise enhance the activity of the particles to be introduced into the polymer matrix.

Porous shelled particles with sequestered payloads in their cores can be incorporated in polymeric materials. For example, a magnetic moiety and a porous silica shell can be used with any of a number of deliverable payloads. When incorporated into a polymeric matrix, the core provides the desirable physical property (magnetic response, in this example) while the porous shell provides the means for passive delivery of the deliverable payload. These payloads can include anti-microbial agents, fragrances, pharmaceuticals (e.g., antibiotics), nutraceuticals (e.g., vitamin E), rapid blood clotting agents (for wound care), proteins, enzymes, antibodies or nanoparticles. Porous particles without a core can also be produced using methods well known in the art and used to deliver the above-mentioned payloads from within the polymer matrix. To further control the delivery of the payload, the polymer matrix into which the particles are embedded can be a dense, porous, photo- or biologically degradable or physically/chemically abradable polymer matrix.

Fibers, fabrics or textiles incorporating core-shell silica nanoparticles can be used for release of a substance of interest, e.g., a biologically active substance such as a growth factor, at a desired location. The controlled release of substances from nanoparticles, specifically for tissue engineering purposes, is well known in the art. In one embodiment, core-shell silica nanoparticles containing growth factors either within the core (to protect them during processing and allow for longer time release) or within the shell (a porous shell for faster release) can be incorporated into a polymeric scaffold or living scaffold matrix that allows for greater stability and even greater control of the release characteristics.

The polymeric materials incorporating core-shell silica nanoparticles can be used (e.g., in fiber form) for anti-counterfeiting or anti-diversion of textiles, clothing, and similar goods. They can also be used in paper currency with equal efficacy. In one embodiment, a method for deterring counterfeiting of goods of interest is provided comprising tagging the goods with an anti-counterfeiting tag comprising a polymeric material or natural material of the invention, or a blend or a mixture thereof, comprising core-shell silica nanoparticles. The polymeric material, the natural material or the core-shell silica nanoparticles can have well-defined or recognizable characteristics, such as size, shape, composition or architecture characteristics.

The polymeric materials incorporating core-shell silica nanoparticles can also be used (e.g., in fiber or film form) for the delivery of fragrances, antibacterial or antimicrobial agents, and other pharmaceuticals or nutraceuticals.

In one embodiment, a method for releasing a substance of interest in a desired location is provided comprising:

providing a material, wherein the material comprises:

a polymeric material, a natural cellulose-based or protein-based material, or a blend or a mixture thereof, and

core-shell silica nanoparticles, wherein:

the core-shell silica nanoparticles comprise the substance of interest within the cores or within the shells; and

placing the material in the desired location, under release conditions whereby the substance of interest is released.

In one aspect, the substance of interest is a pharmaceutical, nutraceutical, veterinary, fragrance, anti-microbial, anti-clotting or clot-inducing, biologically active, RFID active or catalytic agent. In another aspect, the core-shell silica nanoparticles are porous or have porous shells.

The polymeric materials incorporating core-shell silica nanoparticles can also be employed in chemical sensing or monitoring applications. A method for detecting a condition of interest in a subject is provided comprising:

providing a material, wherein the material comprises:

a polymeric material, a natural cellulose-based or protein-based material, or a blend or a mixture thereof, and

core-shell silica nanoparticles,

wherein the core-shell silica nanoparticles are sensitive to the condition of interest;

contacting the subject with the material;

detecting change in the state of the sensitive core-shell silica nanoparticles indicative of the condition of interest; and

determining the condition of interest in the subject from the detected change.

In another embodiment, the polymeric material comprises pH-sensitive core-shell silica nanoparticles and can be used to monitor the pH of solutions with which the material comes in contact, e.g., sweat pH. In a specific embodiment, a method for monitoring sweat composition in a subject is provided comprising:

providing a material, wherein the material comprises:

a polymeric material, a natural cellulose-based or protein-based material, or a blend or a mixture thereof, and

pH-sensitive core-shell silica nanoparticles;

contacting the material with sweat produced by the subject;

detecting alteration in pH-sensitive properties of the pH-sensitive core-shell silica nanoparticles indicative of a pH change; and

calculating the pH of the sweat produced by the subject from the detected change.

The following examples are offered by way of illustration and not by way of limitation.

### 6. EXAMPLES

### 6.1 Example 1

### Cellulose Acetate Fibers with Fluorescing Nanoparticles for Anti-Counterfeiting Purposes

This example demonstrates the incorporation of fluorescent core-shell silica nanoparticles into cellulose acetate (CA) fibers.

Abstract

Fluorescent core-shell silica nanoparticles were incorporated into cellulose acetate (CA) fibers. The resulting fibers are white under ambient lighting, and fluoresce at 580 nm when exposed to 488 nm wavelength light. The fluorescing nanoparticles used in this example, Cornell dots (C dots), are comprised of a fluorescent dye-containing silica core surrounded by a silica shell. A solution of CA and C dots was electrospun into a nonwoven fabric, and dry spun into single fibers. The weight percent of nanoparticles incorporated was verified using thermogravimetric analysis (TGA). Increasing C dot loading in the spinning dopes above 10% w/w did not result in an increase in C dot content within the final fibers. Scanning electron microscopy indicated some C dot agglomeration within the fibers after spinning. The mechanical properties of the fibers and electrospun fabrics were not negatively affected by C dot addition, even though final loading constituted nearly one-third of the weight of the fibers.

Background

Although it is relatively simple to create fluorescent signal in fibers with fluorescent dyes, there is a need in the art for a method for better containing dyes in fibers if longer-term fluorescence is desired. One way this can be accomplished is by using nanoparticles mixed in to the matrix of, or to coat the surface of, a polymer fiber. This example describes the creation of an anti-counterfeit device using Cornell dots (C dots) (Ow, H., Larson, D., Srivastava, M., Baird, B., Webb, W., Wiesner, U., “Bright and Stable Core-Shell Fluorescence Silica Nanoparticles.” Nano Letters, 2005. 5(1): p. 113-117), safe fluorescent core-shell silica nanoparticles, which impart a unique fluorescence signal to cellulose acetate fibers.

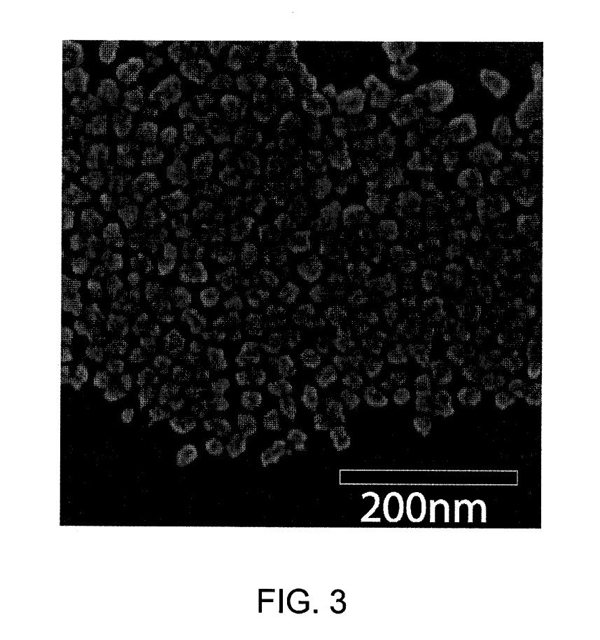

C dot nanoparticles are composed of a dye rich core surrounded by a silica shell, which exhibits fluorescent emission when excited by an external light source at a specific wavelength. The 25 nm C dots are 20-30 times brighter than single fluorescent dye molecules, resistant to quenching, and exhibit greater resistance to photo bleaching (Ow, H., Larson, D., Srivastava, M., Baird, B., Webb, W., Wiesner, U., “Bright and Stable Core-Shell Fluorescence Silica Nanoparticles.” Nano Letters, 2005. 5(1): p. 113-117). The silica shell allows the particles to maintain brightness for longer than a fluorescent dye solution (FIG. 2) (Burns, A., Ow, H., Wiesner, U. “Fluorescent core-shell silica nanoparticles: towards Lab on a Particle architectures for nanobiotechnology.” Chemical Society Review, 2006. s 35: 1028-1042). These nanoparticles can be dispersed in several different solvents, including water and acetone, without degradation (FIG. 3). To disperse the C dots in a non-polar solvent, such as benzene or diethyl ether, surface modification of the nanoparticles is required. The only solvents that the C dots cannot be dispersed in are strong acids and bases, which could dissolve the silica shell. Additionally, the dye encapsulated within the nanoparticles can resist degradation at temperatures up to 150° C., depending on dye structure and heat duration (Burns, A., Ow, H., Wiesner, U. “Fluorescent core-shell silica nanoparticles: towards Lab on a Particle architectures for nanobiotechnology.” Chemical Society Review, 2006. s 35: 1028-1042; Burns, A., Sengupta, P., Zedayko, T., Baird, B., Wiesner, U. “Core-shell fluorescent silica nanoparticles for chemical sensing: towards single particle laboratories.” Small, 2006.1 2(6): 723-726; Herz, E., Burns, A., Lee, S., Sengupta, P., Bonner, D., Ow, H., Lidell, C., Wiesner, U. “Fluorescent core-shell silica nanoparticle: an alternative radiative materials platform.” Proceedings of the SPIE: Colloidal Quantum dots for Biomedical Application, 2006. 6096: 1-12; Larson, D. R., Ow, H., Vishwasrao, H. D., Heikal, A. A., Wiesner, U., Webb, W. W. “Silica nanoparticle architecture determines radiative properties of encapsulated fluorophores.” Chemistry of Material, 2008. 20(8): 2677-2684).

In this example, the C dots were incorporated into cellulose acetate (CA) fibers during the fiber spinning process to create an anti-counterfeiting device. Cellulose acetate was used because it is relatively simple to spin, and the optimal solvent, acetone, is compatible with the as-made C dots. Even though cellulose acetate forms a relatively weak fiber, it is preferable in this experiment because of its low cost and spinnability. If several different wavelengths of nanoparticles are spun into these CA fibers, and the fibers are arranged in an intricate pattern, an anti-counterfeit device can be made. Anti-counterfeit methods are known in the art that use quantum dots as fluorescent taggants in security inks, papers and explosives (McGrew, S., Quantum dot security device and method, U.P. Office, Editor. 2004). Unfortunately, quantum dots contain heavy metals, such as toxic cadmium or lead, which have the potential to leak and disrupt the chemistry of the location at which the particles are placed. C dots, however, exhibit comparable brightness to quantum dots, but without the toxicity. Thus, anti-counterfeiting methods utilizing C dots have greater commercial potential than methods using quantum dots.

The C dots were incorporated into cellulose acetate fibers spun by two distinct methods: electrospinning and dry spinning. These two methods illustrated that the C dots can be dispersed in a nonwoven fabric, or an individual fiber. Electrostatic fiber spinning or ‘electrospinning’ is a unique method for forming fibers with submicron scale diameters through electrostatic forces. When an electrical force is applied at the interface of a liquid polymer, a charged jet is ejected. The jet initially extends in a straight line, then moves into a whipping motion caused by the electro-hydrodynamic instability at the tip. As the solvent evaporates, the polymer is collected, e.g. onto a grounded piece of aluminum foil as a nonwoven mat (Kim, C. K., D S. Kim, S Y. Kang, M Marquez, and Y L. Joo, “Structural Studies of Electrospun Cellulose Nanofibers.” Polymer, 2006. 47(14): p. 5097-5107). Dry spinning is a technique commonly used to spin cellulose acetate fibers, and is a common industrial spinning method. The dope solution is composed of a cellulose acetate-acetone mixture containing approximately 15-30 wt % polymer. The dope solution is extruded from a spinneret, and the solution is drawn down to a roller at the bottom of the spinning column (Sano, Y., “Drying Behavior of Acetate Filament in Dry Spinning.” Drying Technology, 2001. 19(7): p. 1335-1359).

By forming nanoparticle-containing fibers through electrospinning and dry spinning, an anti-counterfeiting device was created. The results show that it is possible to create a unique method for tagging and identifying legitimate items using fluorescing nanoparticles and CA fibers.

Materials And Methods

Materials

Cellulose acetate (M_{w}=30,000 and M_{w}=50,000) was supplied by Aldrich Chemical Co Ltd (St. Louis, Mo.). Acetone was purchased from VWR Scientific (West Chester, Pa.). The C dots were made by the Wiesner lab in the Materials Science and Engineering department at Cornell University using previously described techniques, and incorporating TRITC dye (Ow, H., Larson, D., Srivastava, M., Baird, B., Webb, W., Wiesner, U., “Bright and Stable Core-Shell Fluorescence Silica Nanoparticles.” Nano Letters, 2005. 5(1): p. 113-117; Larson, D. R., Ow, H., Vishwasrao, H. D., Heikal, A. A., Wiesner, U., Webb, W. W. “Silica nanoparticle architecture determines radiative properties of encapsulated fluorophores.” Chemistry of Material, 2008. 20(8): 2677-2684).

Preparation of Electrospun and Dry Spun Solutions

The electrospun fabrics were manufactured using low molecular weight CA (M_{w}=30,000), and the dry spun fibers were formed with a high molecular weight CA (M_{w}=50,000). In both cases, CA was dissolved in a 3:1 v/v acetone: water solution. The C dots were suspended in acetone, and added to the CA solutions in 5, 10, and 15 vol %. These samples will be designated as X, Y, and Z, respectively. The solution of cellulose acetate, acetone, water and C dots were mixed on an Innova™ 2300 platform shaker (New Brunswick Scientific Co., NJ) for twenty-four hours prior to fiber formation.

Electrospinning

The electrospinning apparatus consisted of a programmable syringe pump (Harvard Apparatus, MA) and a high-voltage supply (Gamma High Voltage Research Inc., FL). Electrospinning required a 17 wt % concentration of the lower molecular weight CA, and was spun from a 20 G needle at 0.3 ml/hr with an applied voltage of 14 kV. The nonwoven fabric was formed on a grounded aluminum collector 15 cm from the spinneret tip. The fabric was air dried for approximately 2 hours before storage in a desiccator.

Dry Spinning

Dry spinning was performed using a dry spinning apparatus produced by Alex James & Associates, Inc., Greer, S.C. The higher molecular weight concentration of CA was used for this purpose; a 17 wt % solution was spun and drawn onto a spindle. The fibers were air dried for approximately 2 hours prior to storage in a desiccator. This equipment was not industrial-level, and was therefore subject to some sample-to-sample variation.

Thermogravimetric Analysis

A TGA 2050 apparatus from Texas Instruments was used to determine the actual weight percent of nanoparticles spun into the CA fibers. Both the electrospun and dry spun fibers were heated from 25° C. to 400° C. at a step rate of 20° C. per minute to remove all organic material, while retaining the inorganic (i.e. the silica from the C dots).

Confocal Microscopy

A Leica TCS SP2 laser confocal scanning microscope was used to examine the visible fluorescence of the C dots within the cellulose acetate fibers. The electrospun fabrics were imaged dry at 40×, while the single dry spun fibers were imaged under oil immersion at 40×. Both the electrospun and dry spun samples were imaged under a red fluorescence filter with 460-500 nm excitation.

Scanning Electron Microscopy

Morphology and fiber diameter for the electrospun and dry spun fibers were examined using a Leica 440 scanning electron microscope (SEM) at 25 kV and 30 kV. The dry spun samples were imaged under 25 kV, while the electrospun samples were imaged under 30 kV with an electron backscatter detector. Samples were coated for 30 seconds with 10 nm Au—Pd to prevent charging.

Mechanical Testing

The mechanical testing was conducted according to ASTM standards D3822 and D638-02a with an Instron 5566. These standards measure the modulus, tensile stress at break, and tensile strain at break that the CA fibers and fabrics can survive prior to failure. Ten dry spun fiber samples were broken from an initial length of 20 mm at a rate of 100 mm/min. The electrospun mats were initially cut into dumbbells with a 3.18 mm width and 9.53 mm length. These samples were then broken at 100 mm/min. The data was then normalized by weight in order to take into account slight variations in sample thickness. The normalized data was then analyzed using the student's t-test to determine if the control and nanoparticle-containing samples were statistically different from each other. The control sample was compared to each of the samples containing C dots to determine the influence their incorporation had on the mechanical properties of the fibers and fabrics.

Results and Discussion

Thermogravimetric Analysis (TGA)

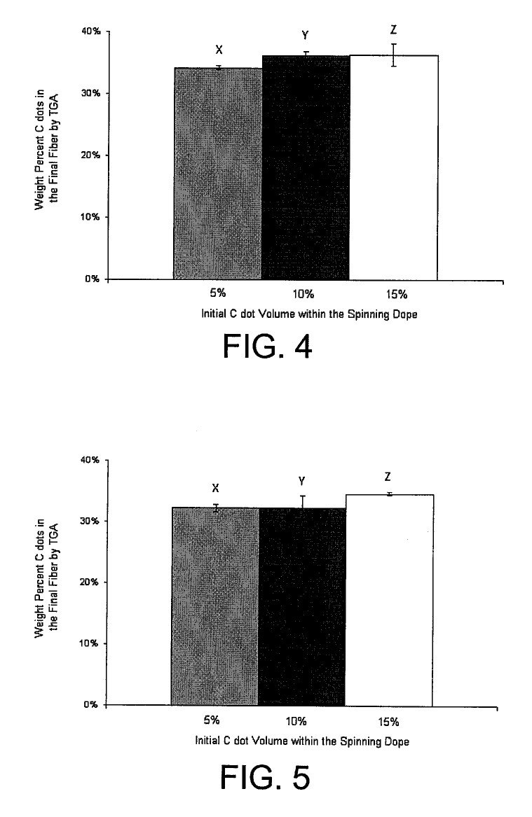

In this example, TGA was used to investigate the final concentration of nanoparticles within CA fibers after spinning. Although the spinning solutions contained sufficient C dots to create fibers with up to 47% C dots by weight, TGA measurements indicated that the electrospun samples actually contained 34±0.28%, 36±0.66% and 36±1.81% C dots in the X, Y and Z C dot samples, respectively (FIG. 4). An ANOVA analysis performed on this data confirmed that the samples contained statistically equal nanoparticle concentrations. The dry spun fibers were also estimated to contain up to 47% C dots by weight, but actually contained 32±0.62%, 32±0.82% and 34±0.22% C dots within the X, Y and Z C dot samples, respectively (FIG. 5). Again, an ANOVA analysis performed on this data confirmed that the samples contained statistically equal nanoparticle concentrations. The TGA data suggests that there is a maximum amount of C dots that can be incorporated into the fibers. Regardless of how many more C dots are added to the spinning solution, no more than 35% or 33% w/w nanoparticles ended up in the electrospun or dry spun fibers, respectively. Therefore, the samples will be referred to as X, Y, Z, and will be used to compare results between fabrics and fibers with and without nanoparticle incorporation.

SEM and Confocal Images

In this example, SEM images were used to examine the morphology of the CA fibers, provide evidence of C dot agglomeration within fibers, and determine average fiber diameter. A summary of the electrospun fiber diameters is given in Table I. The electrospun nanoparticle-containing samples were imaged under an SEM with an electron backscatter detector (EBSD), and an accelerating voltage of 30 kV. The increased accelerating voltage allowed the EBSD to show differences in atomic mass within the fibers through contrast. For the purpose of this research, a contrast between the silica nanoparticles and CA was desired.

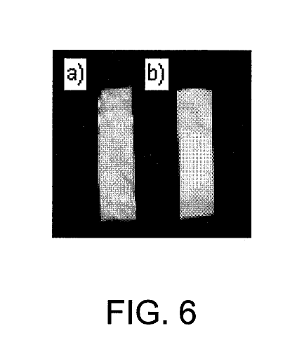

Additionally, confocal microscopy was used to confirm that the incorporated C dots retained their fluorescent properties in both electrospun and dry spun CA fibers. To the naked eye, under ambient lighting, neat CA samples and samples containing C dots both appear uniformly white (FIG. 6). However, under 488 nm excitation, the C dot containing fibers and fabrics exhibited fluorescent properties.

TABLE I
Summary of electrospun fiber diameters.

| | Control | X | Y | Z |
|---|---|---|---|---|
| Average | 1.23 | 1.37 | 1.50 | 2.42 |
| Fiber | | | | |
| Diameter | | | | |
| (μm) | | | | |
| Standard | 0.811 | 0.702 | 0.574 | 2.082 |
| Deviation | | | | |
| (μm) | | | | |

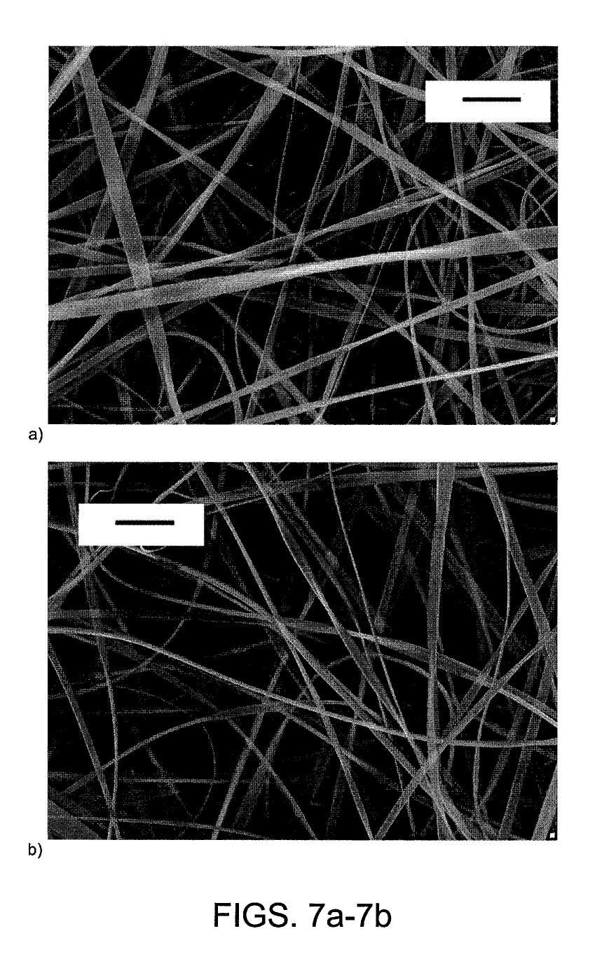

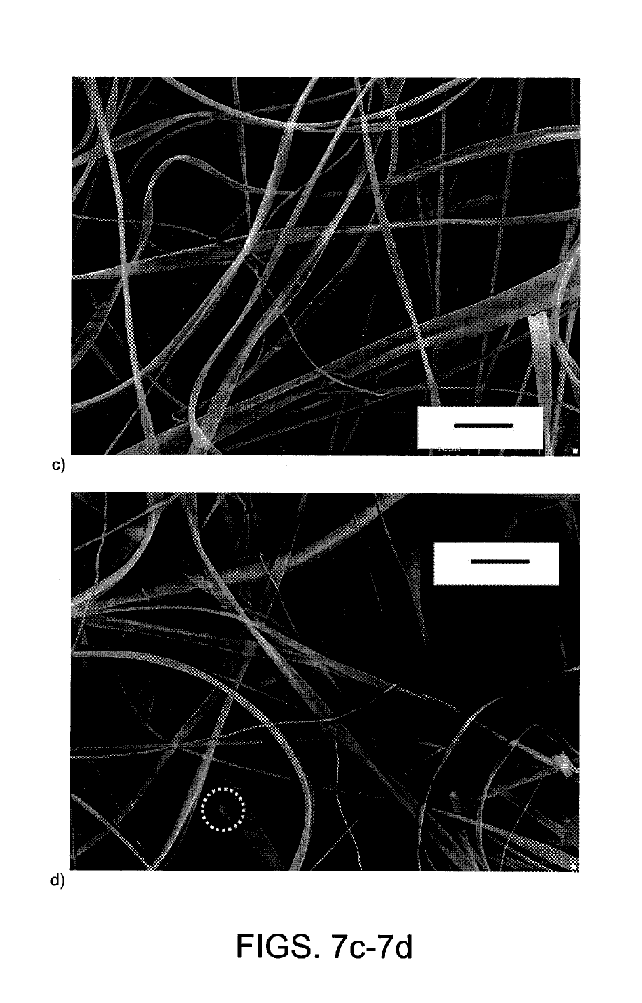

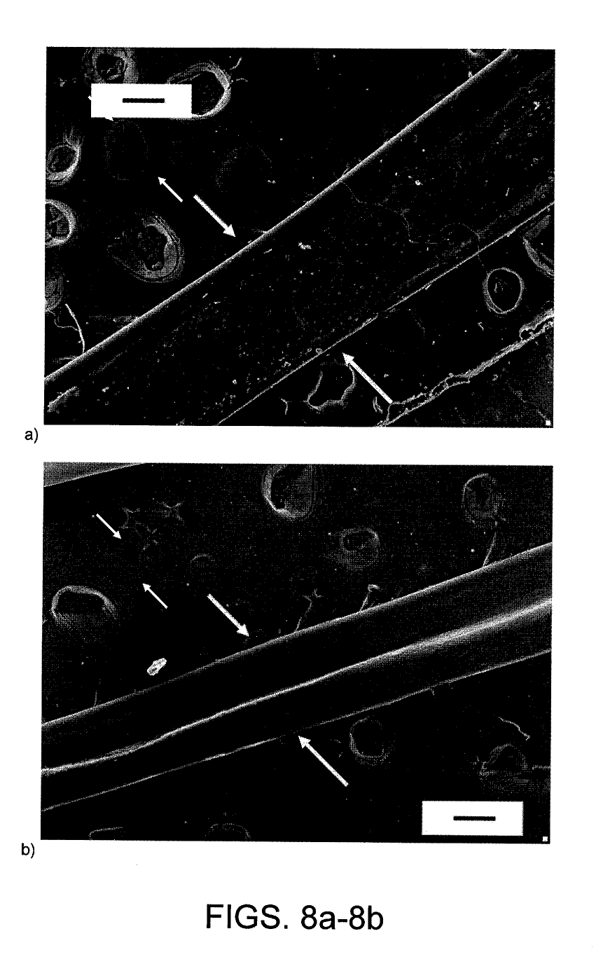

Representative SEM images of neat CA fibers prepared by electrospinning and dry spinning are presented in FIGS. 7a and 8a. The SEM images show the electrospun CA fibers to be smooth, with a ribbon shaped cross-section. The dry spun fibers, shown between the arrows, are shown to have non-uniform cross-sections and large pores on the fiber surface as a result of solvent evaporation during the spinning process (FIG. 8a).

Representative SEM images of electrospun CA fibers samples X, Y and Z are presented in FIGS. 7b, 7c and 7d. The SEM images show that samples X, Y and Z exhibit the same morphology as the control sample: smooth and ribbon-shaped. The control, X, and Y samples all had diameters consistent with previous reports (Xiang, C., Frey, M. W., Taylor, A. G., Rebovich, M. “Selective chemical absorbance in electrospun nonwovens.” Journal of Applied Polymer Science, 2006. 106: 2363-2370). Sample Z exhibited a slight increase in fiber diameter, but the results are still within an acceptable range of previous studies on electrospun CA. Under the EBSD, several contrast points were observed in sample Z. Since these areas of contrast are approximately 1-2 μm, they provide evidence of C dot agglomeration within the fibers. The dry spun fibers for samples X, Y and Z had the same non-uniform cross-sections with large pores as the control sample. The diameters of the dry spun fibers were variable due to sample-to-sample variation, as well as imperfections in the processing method (FIG. 8b).

In general, the SEM images indicate that the electrospun and dry spun fibers had consistent morphologies, regardless of C dot loading. The electrospun fibers were very smooth, with only a slight increase in fiber diameter for sample Z. The dry spun fibers were all morphologically identical, with the exception of inconsistent diameters due to sample-to-sample variation in the spinning process. The fact that both the neat and C dot spinning dopes produced similar fiber morphologies and diameters seems to indicate that C dots do not perturb the fiber production. However, confocal microscopy of these C dot containing fibers proved that even though these fibers were morphologically similar, their behavior under fluorescent light was different.

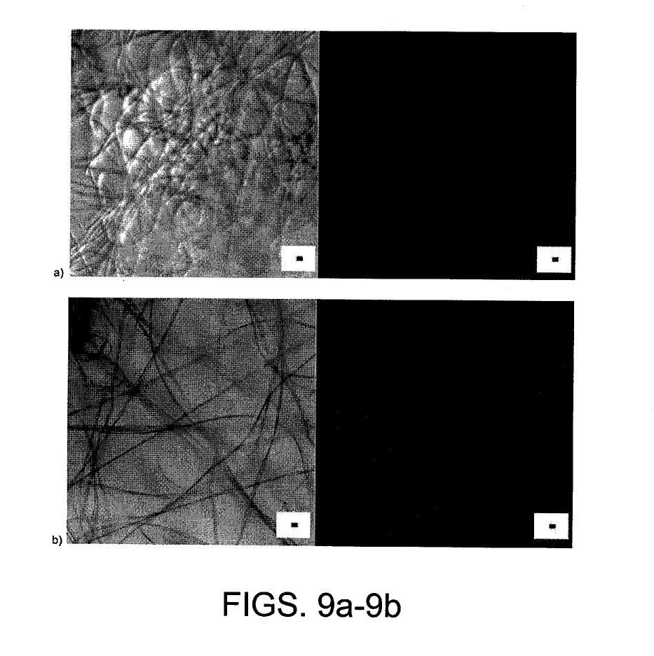

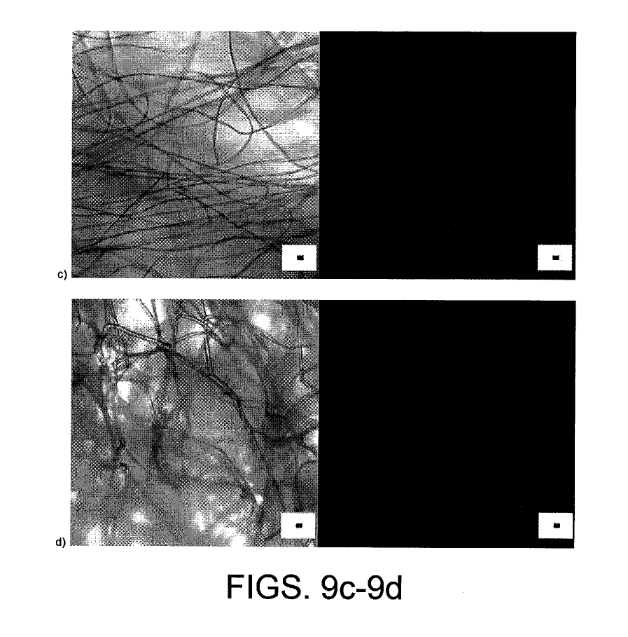

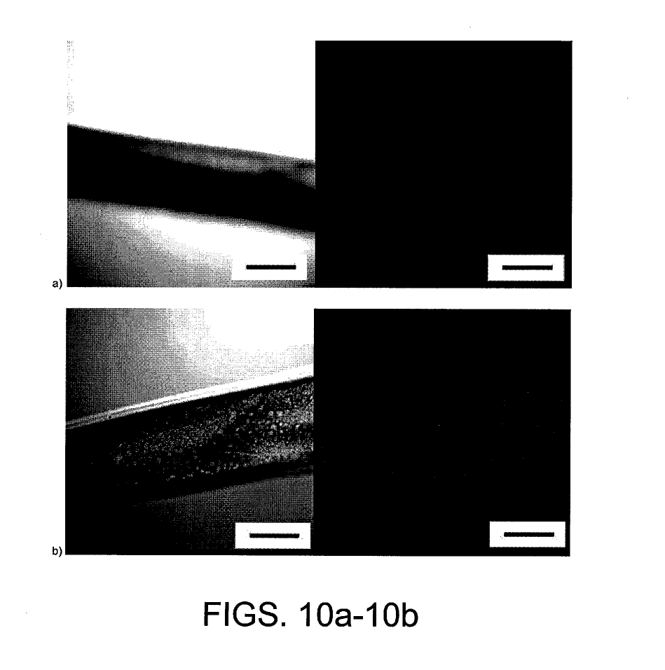

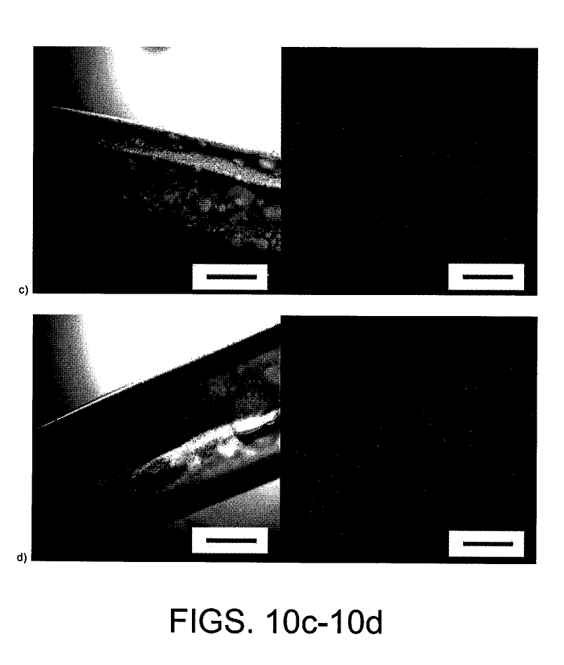

In this example, confocal microscopy was used to confirm that incorporated C dots retained fluorescent properties in both electrospun and dry spun CA fibers. Confocal images of neat electrospun and dry spun CA fibers showed that they appeared white under visible light, and black under 488 nm fluorescent light. Even though a small amount of auto-fluorescence can be observed in FIG. 8a, it is not present where fibers were observed, and can be attributed to light scattering within the microscope. This image confirmed that neat CA fibers did not fluoresce at the target C dot wavelength (FIGS. 9a and 10a).

Confocal images of electrospun CA samples X, Y and Z are presented in FIGS. 9b, 9c and 9d. The confocal images show the CA fibers fluorescing uniformly under 488 nm light (FIGS. 9b, 9c, 9d). As with the neat samples, images taken of the same microscopic field under white light confirm that fibers were present where the fluorescence is observed. Uniform fluorescence was observed along the fibers, which suggest that the C dots were fairly well distributed.

The confocal images for dry spun samples X and Y show uniform fluorescence under 488 nm light (FIGS. 10b, 10c). Sample Z also shows CA fibers fluorescing, but some of the fluorescence can be seen in bright spots followed by areas of sparse fluorescence (FIG. 10d). These spots are much larger than a single 25 nm C dot, which suggests that these bright areas are composed of nanoparticle agglomerates.

When the control, X, Y, and Z C samples were observed with the naked eye under UV light at 340 nm, surprising results were found. The control sample appeared white under the UV light, the same result as under white light. When samples X and Y were observed under UV light, a faint pink color was observed from the fibers. When sample Z was observed, they produced a strong pink color under the UV light. The trends were the same among the electrospun and dry spun samples, but the dry spun samples produced a stronger color under the UV light than the electrospun samples, perhaps due to the larger diameters of the dry spun fibers. This result suggested that the clumping and agglomeration of the C dots within sample Z provided better visible fluorescence in the larger fibers. The C dots agglomerated within the fibers, but the fluorescence was not quenched, as expected from previous studies on C dots, resulting in increased fluorescence (Burns, A., Ow, H., Wiesner, U. “Fluorescent core-shell silica nanoparticles: towards Lab on a Particle architectures for nanobiotechnology.” Chemical Society Review, 2006. s 35: 1028-1042; Herz, E., Burns, A., Lee, S., Sengupta, P., Bonner, D., Ow, H., Lidell, C., Wiesner, U. “Fluorescent core-shell silica nanoparticle: an alternative radiative materials platform.” Proceedings of the SPIE: Colloidal Quantum dots for Biomedical Application, 2006. 6096: 1-12). Therefore, nanoparticle agglomeration allowed the fluorescing fibers to be seen more clearly with the naked eye under UV light.

Statistical Analysis of Mechanical Testing Data

Mechanical testing was conducted according to ASTM standards D3822 and D638-02a. These standards provide a method for measuring the modulus, tensile stress at break, and tensile strain at break that cellulose acetate fibers and fabrics can survive prior to failure during Instron testing.

Once the collection of mechanical data was completed, the effect that the C dot addition had on the mechanical properties of cellulose acetate fibers was analyzed. The average values of modulus, tensile stress, and tensile strain for each of the C dot loadings were compiled, followed by analysis using the student's t-test. These statistical tests were done under the null hypothesis that there was no significant difference between the values of the control and the C dot containing samples. A percentage of lower than 5% indicated that there was a significant difference between the control values, and the value of the C dot containing samples. Each of the properties are shown and analyzed below.

Electrospun Samples

Modulus

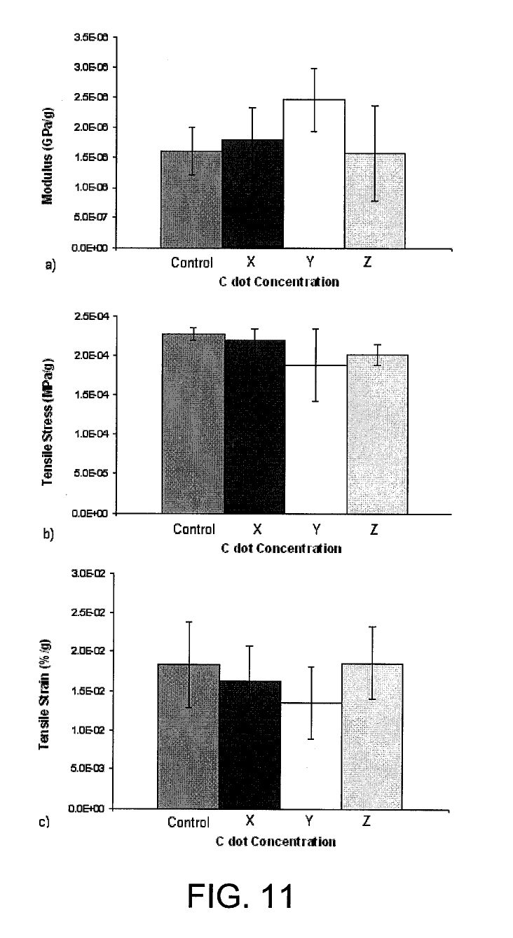

The t-test analysis indicated that the modulus values for the control, X, and Z samples were statistically similar to one another. The modulus value for sample Y was discovered to be statistically different from the others, but this difference is less than a factor of two (FIG. 11a).

Tensile Stress

The t-test stated that the Y and Z samples had tensile stresses at break that were significantly different to those of the control and the X samples (FIG. 11b). However, even though samples Y and Z had lower tensile stress values than the control and X, the values were not low enough to suggest that the nanoparticles deteriorated the mechanical properties.

Tensile Strain

The tensile strain at break for the electrospun mats did not appear to be affected by the addition of the nanoparticles. The values for tensile strain at break for the control samples were not significantly different from the values compiled for the samples containing C dots (FIG. 11c). The addition of the C dots did not affect the tensile strain at break for the nonwoven fabrics.

Dry Spun Samples

Modulus and Tensile Stress

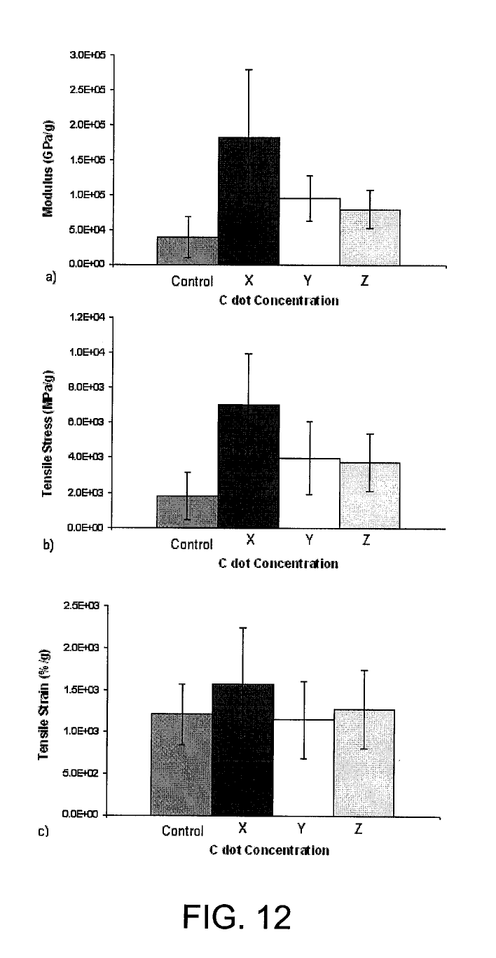

The t-test analysis indicated that the modulus and tensile stress of the CA fibers was increased by the addition of the nanoparticles (FIGS. 12a and 12b). Even though sample X exhibits a modulus and tensile stress twice that of sample Y, this result can most likely be attributed to sample-to-sample variation and processing challenges. The incorporation of C dots led to a general increase in modulus and tensile stress for the dry spun fibers.

Tensile Strain

The tensile strain at break for the dry spun fibers did not appear to be affected by the addition of the nanoparticles. Once again, the tensile strain showed a maximum for sample X, but all of the other samples exhibited comparable values to that of the control (FIG. 12c). The t-test results concluded that the addition of the C dots had no effect on the tensile strain at break.

The tensile testing for the electrospun and dry spun samples provided very interesting results, especially considering that the C dot containing samples had statistically equal nanoparticle concentrations. Though nanoparticle incorporation had some effect on the mechanical properties of the fibers, they did not significantly hinder them. The control and nanoparticle-containing samples did not have vastly different mechanical properties. It is significant that even though approximately 10% w/w silica nanoparticles were added to the fiber, they did not negatively impact the mechanical properties.

Conclusions

In this example, fluorescent core-shell silica nanoparticles were successfully incorporated into CA fibers for use as an anti-counterfeiting device. TGA analysis confirmed that increasing the amount of C dots in the spinning solution did not increase the final weight percent of C dots within the fibers. SEM images proved that the nanoparticle incorporation did not affect the general morphology and size of the fibers. Confocal microscopy confirmed that the C dots fluoresce within the fiber at a specific wavelength of light, and can agglomerate within the fibers. Visual inspection under UV light showed that the nanoparticle agglomeration provided for better visibility of the fluorescence with the naked eye. ASTM standards and the student's t-test were used to assess the mechanical properties of the fibers and fabrics. These tests determined that the addition of the C dots did not significantly affect the mechanical properties of the fibers. This example demonstrates a single color anti-counterfeiting material; however, many different colors may be incorporated into C dots, thereby increasing the anti-counterfeiting effectiveness of any fibers produced (Herz, E., Burns, A., Lee, S., Sengupta, P., Bonner, D., Ow, H., Lidell, C., Wiesner, U. “Fluorescent core-shell silica nanoparticle: an alternative radiative materials platform.” Proceedings of the SPIE: Colloidal Quantum dots for Biomedical Application, 2006. 6096: 1-12). This example provides compelling evidence that fibers containing fluorescent silica nanoparticles have the potential to be used as an anti-counterfeiting device that is very difficult for counterfeiters to duplicate, and simple for users to positively identify.

### 6.2 Example 2

### Methods of Core-Shell Nanoparticle Synthesis

Synthesis Methods for 30 Nm TRITC Core-Shell Silica Particles

100 microliters of tetramethylrhodamine dye dissolved in dimethylsulfoxide were conjugated to a concentration of 4.5 mM, with a 50× molar excess of 3-aminopropyltrimethoxysilane. The reaction was allowed to occur overnight under nitrogen.

21.2 mL ethanol (200 Proof), 386 uL deionized water, and 2.58 mL 2M ammonia in ethanol were added to a round bottom flask. Magnetic stir bar mixing was started and the 100 uL of dye conjugate was added. After the dye was well dispersed in the solution, 287 uL tetraethylorthosilicate (TEOS) was added. The core formation reaction was allowed to proceed under 8 hours of stirring.

After the 8 hour core reaction, a shell of pure TEOS was added to the desired thickness. For 30 nm TRITC particles, 25 uL TEOS was added every 15 minutes 23 times.

Particles were cleaned by dialysis into water or other desired polar solvent.

Synthesis Methods for 180 Nm TRITC Core-Shell Silica Particles

For a 200 mL reaction, 1.2 mL TRITC (4.5 mM concentration) was mixed with a 50× molar excess of 3-aminopropyltrimethoxysilane. The mixture was allowed to react under a nitrogen atmosphere overnight.

173.7 mL ethanol, 17.4 mL ammonium hydroxide, and 8.9 mL TEOS were added to a round bottom flask. The mixture was mixed well and the 1.2 mL of TRITC conjugate was added. The reaction was allowed to proceed for 12 hours.

A pure TEOS shell was added to the desired thickness or overall particle size. To avoid secondary nucleation, only 1 uL TEOS was added per mL of reaction size per 15 minutes.

Particles were cleaned by centrifugation into the desired solvent.

Synthesis Methods for Mesoporous Magnetic Nanoparticles

Chemicals: Hexadecyltrimethylammonium bromide (appx. 99%), ethyl acetate (ACS grade), tetraethyl silane (TEOS) (≧99%, GC), ammonium hydroxide (29%), acetic acid (gracial), hydrochloric acid (36.5-38%), ethanol (absolute, anhydrous), deionized water (Milli-Q, 18.2 Ω·cm), chloroform (AR grade), 1-octadecene (AR grade), iron (III) oxide (FeO(OH)) (hydrated, 30-50 mesh), oleic acid (technical grade, 90%), acetone (AR grade). All chemicals were used without purification.

Synthesis of magnetic nanoparticles: 8-9 nm iron oxide nanoparticles were synthesized as reported in the literature (William W. Yu, J. C. F., Cafer T. Yavuz and Vicki L. Colvin (2004). “Synthesis of monodisperse iron oxide nanocrystal by thermal decomposition of iron carboxylate salts.” Chem. Commun.: 2306-2307). FeO(OH) (0.356 g) was mixed together with oleic acid (4.52 g) and 1-octadecene (10 mL) in three-necked flask. While stirring, nitrogen gas was purged through the mixture around 10 min before heating to 320° C. for 1 hr. After cooled to room temperature, the as-made nanoparticles were cleaned by the addition of acetone and separated by centrifugation. The spun particles were re-dispersed back in hexane and washing step was repeated 2 more times. The particles were suspended in chloroform for the next step.

Phase transfer of magnetic particles to aqueous: 15 mg of magnetic nanoparticles in 0.5 mL of chloroform was added to 5 mL of CTAB solution (54.8 mM). The mixture was stirred until homogeneous microemulsion was formed. Then, the solution was transferred to the pre-heated oil bath at 70° C. to evaporate off chloroform as well as induce the interaction between hydrophobic chains of 2 surfactants for 10 min.

Synthesis of mesoporous silica nanoparticles incorporating with magnetic nanoparticles: The 0.5 mL of as-made CTAB-stabilized magnetic nanoparticles was diluted in 10 mL of water. 0.88 mL of ethyl acetate was next added in solution under stirring. After 5 minutes of the addition of 0.27 mL of NH₄OH and 50 mL of TEOS, 3.69 mL of water was added into the reaction and let it proceeded for another 10 minutes. Aliquot was taken from the reaction mixture every 1 minute and neutralized by adding 2 M HCl. The resulting material was cleaned by centrifugation using water and ethanol. To remove the surfactant templates, in the last washing, particles were redispersed in ethanol to prepare acetic acid-ethanol solution. Centrifugation in water and ethanol was employed in a cleaning step.

### 6.3 Example 3

### Electrospun Fibers Incorporating pH-Sensitive Nanoparticles

In today's health-conscious world, physical fitness and wellness is strongly promoted. New and better technology is constantly in demand for monitoring physical performance and health. This example demonstrates the creation of a functional fabric that monitors sweat composition through the incorporation of pH-sensitive core-shell silica nanoparticles into electrospun fabrics.

Introduction

Understanding sweat composition is vital for understanding the changes in extracellular fluid and nutritional replacement in the human body (Mark J. Patterson, S. D. R. G., Myra A. Nimmo, Variations in regional sweat composition in normal human males. Experimental Physiology, 2000. 85(6): p. 869-875). The composition of human perspiration is a reflection of exercise, heat exposure, the duration of sweating, and the rate of sweat secretion (T. Verde, R. J. S., Paul Corey, Robert Moore, Sweat composition in exercise and in heat. Journal of Applied Physiology, 1982. 53(6): p. 1540-1545). However, previous research has proven that the composition of sweat is mostly water, with varying amounts of minerals and electrolytes: sodium, potassium, calcium, magnesium, chloride, lactic acid, and bicarbonate (Mark J. Patterson, S. D. R. G., Myra A. Nimmo, Variations in regional sweat composition in normal human males. Experimental Physiology, 2000. 85(6): p. 869-875; T. Verde, R. J. S., Paul Corey, Robert Moore, Sweat composition in exercise and in heat. Journal of Applied Physiology, 1982. 53(6): p. 1540-1545). While sweat secretion rate affects the concentration of sodium, chlorine, lactic acid and bicarbonate, the most significant change in sweat composition during exercise is in sodium ions (Allan, J. R. W., C. G., Influence of acclimatization on sweat sodium concentration. Journal of Applied Physiology, 1971. 30: p. 708-712; Falk, B., Bar-Or, O., MacDougall, J. D., McGillis, L., Calvert, R. & Meyer, F., Sweat lactate in exercising children and adolescents of varying physical maturity. Journal of Applied Physiology, 1991. 71: p. 1735-1740; Kaiser, D., Songo-Williams, R. & Drack, E., Hydrogen ion and electrolyte excretion of the single human sweat gland. Pflugers Archiv, 1974. 349: p. 63-72; Sato, K. D., R. L., Regional and individual variations in the function of the human eccrine sweat gland. Journal of Investigative Dermatology, 1970. 54: p. 443-449; Yosipovitch, G., Reis, J., Tur, E., Blau, H., Harell, D., Moduchowicz, G. & Boner, G., Sweat electrolytes in patients with advanced renal failure. Journal of Laboratory and Clinical Medicine, 1994. 124: p. 808-812).

A relationship has been reported, moreover, between pH and the sodium concentration in sweat. Studies have found that the greater the sodium concentration, the higher the sweat pH (Kaiser, D., Songo-Williams, R. & Drack, E., Hydrogen ion and electrolyte excretion of the single human sweat gland. Pflugers Archiv, 1974. 349: p. 63-72; Buono, M. J., Ball, K. D., Kolkhurst, F. W., Sodium ion concentration vs. sweat rate relationship in humans. Journal of Applied Physiology, 2007. 103: p. 990-994). Since sodium concentration is related to dehydration, it is logical to suggest that sweat pH can be useful in monitoring hydration levels (Allan, J. R. W., C. G., Influence of acclimatization on sweat sodium concentration. Journal of Applied Physiology, 1971. 30: p. 708-712; Brouns, F., Heat—sweat—dehydration—rehydration: a praxis oriented approach. Journal of Sports Science, 1991. 9: p. 143-152).

To maximize organ function and overall health, it is crucial to balance water and electrolyte levels (Mack, G. W., Nadel, E. R., Body fluid balance during heat stress in humans. Environmental physiology, ed. M. J. Fregly, Blatteis, C. M. 1996, New York: Oxford University Press. 187-214; Sawka, M. N., Body fluid responses and hypohydration during exercise heat stress. Human performance physiology and environmental medicine at terrestrial extremes, ed. K. B. Pandolf, Sawka, M. N., Gonzalez, R. R. 1988, Indianapolis: Cooper Publishing Group. 227-266; Sawka, M. N., Montain, S. J., Fluid and electrolyte supplementation for exercise heat stress. American Journal of Clinical Nutrition, 2000. 72: p. 564-572). Generally, well-conditioned athletes have sweat sodium concentrations of 5-30 mmol/liter, while unconditioned individuals have concentrations of 40-100 mmol/liter (Wenger, C. B., Human heat acclimatization. Human Performance Physiology and Environmental Medicine at Terrestrial Extremes, ed. K. B. Pandolf, Sawka, M. N., Gonzalez, R. R. 1988, Indianapolis: Benchmark Press. 153-197). Researchers have observed that as sweating rate increases, so do electrolyte levels. During intense activities, athletes can lose 1-8% of their body mass in sweat, amounting to a loss of 150 mmol/hr of sodium (Costill, D. L., Sweating: its composition and effects on body fluids. Annals of the New York Academy of Sciences, 1977. 301: p. 160-174; Rehrer, N. J., Fluid and electrolyte balance in ultra-endurance sport. Sports Medicine, 2001. 31: p. 160-174; Costill, D. L., Cote R., Fink W., Muscle water and electrolytes following varied levels of dehydration in man. Journal of Applied Physiology, 1976. 40: p. 6-11; Consolazio, C. F., Matoush, L. O., Nelson, R. A., Harding, R. S., Canham, J. E., Excretion of sodium, potassium, magnesium and iron in human sweat and the relation of each to balance and requirements. Journal of Nutrition, 1963. 79: 407-415). In the present example, an electrospun fabric for the monitoring of sodium and hydration levels was created containing pH-sensitive nanoparticles.

The pH-sensitive nanoparticles employed in this study had a core-shell architecture (Burns, A., Ow, H., Wiesner, U., Fluorescent core-shell silica nanoparticles: towards “Lab on a Particle” architectures for nanobiotechnology. Chemical Society Reviews, 2006. 35: p. 1028-1042). These core-shell silica nanoparticles, termed C dots, use a TRITC dye core as an internal reference, allowing for quantitative concentration measurements. By placing a FITC sensor dye on the surface of the silica shell, the maximum amount of surface area is exposed to the environment. These nanoparticles were electrospun into cellulose acetate (CA) fibers to create a pH-sensitive fabric.

Preparation of Electrospun Solutions

The electrospun fabrics were manufactured using 30,000 g/mol cellulose acetate, dissolved in a 3:1 v/v acetone: water solution. The C dots were suspended in water, and added to the cellulose acetate (CA) solutions to make up 15 vol %. The solution of CA, acetone, water and C dots were mixed on an Innova™ 2300 platform shaker (New Brunswick Scientific Co., NJ) for twenty-four hours prior to fiber formation.

Electrospinning

The electrospinning apparatus consisted of a programmable syringe pump (Harvard Apparatus, MA) and a high-voltage supply (Gamma High Voltage Research Inc., FL). Electrospinning was performed using a 17 wt % concentration of cellulose acetate and was spun from a 20 G needle at 0.3 ml/hr with an applied voltage of 14 kV. This concentration of cellulose acetate was suitable for the particular electrospinning apparatus used; other suitable concentrations can be readily determined by the skilled practitioner.

The nonwoven fabric was formed on a grounded aluminum collector 15 cm from the spinneret tip. The fabric was air dried for approximately 2 hours before storage in a desiccator.

Confocal Microscopy and Analysis

A Leica TCS SP2 laser confocal scanning microscope was used to examine the visible fluorescence of the pH-sensitive C dots within the cellulose acetate fibers. The fabrics were imaged under water immersion at 20× with both red (460-500 nm) and green (480/40 nm) fluorescence filters. Confocal microscopy was used to establish that the pH-sensing nanoparticles can function as a ratiometric pH-sensing device within electrospun fibers. The results were determined through comparisons of the individual reference (TRITC) and sensor (FITC) signals from the confocal images (FIG. 15). After images were collected, each green and red pixel were compared to illustrate a relationship between fluorescence intensity and pH (Burns, A., Ow, H., Wiesner, U., Fluorescent core-shell silica nanoparticles: towards “Lab on a Particle” architectures for nanobiotechnology. Chemical Society Reviews, 2006. 35: p. 1028-1042). The intensity of the reference dye remained the same, but the intensity of the sensor dye varied with pH.

FIG. 15 shows the relationship between fluorescence intensity and pH for electrospun fabrics containing the pH-sensor core-shell silica nanoparticles. The results show that the ratio of FITC/TRITC intensity increases with pH (FIG. 15), and that the nanoparticles functioned as pH sensors in the fabric.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

1-2. (canceled)

3. The material of claim 46 in the form of a sheet, fiber, film, spray or bulk solid.

4-5. (canceled)

6. The material of claim 46 having a concentration of core-shell silica nanoparticles between 0.001 and 90 weight percent.

7. The material of claim 46 having a concentration of core-shell silica nanoparticles between 1 and 60 weight percent.

8-27. (canceled)

28. The material of claim 46 having an add-on of core-shell silica nanoparticles between 0.001 and 50 weight percent.

29. The material of claim 46 having an add-on of core-shell silica nanoparticles between 0.01 and 5 weight percent.

30-45. (canceled)

46. A material comprising:
at least one polymeric material selected from the group consisting of cellulose acetate, nylon, rayon, modacrylic, olefin, acrylic, polyester, polylactic acid, polylactic-co-glycolic acid (PLGA), polyurethane and aramid, or
at least one natural material selected from the group of cellulose-based materials consisting of cotton, linen, ramie and hemp or the group of protein-based materials consisting of wool, silk, angora, cashmere, mohair and alpaca, or
a blend or a mixture thereof; and
core-shell silica nanoparticles,
wherein the core-shell silica nanoparticles:
are attached to the polymeric or natural material via covalent reaction between surface modification of the silica and the surface of the polymeric or natural material or within the matrix of the polymeric material, or
are mechanically entrapped within the polymeric material.

47. The material of claim 46 wherein the silica is surface-modified by treatment with maleimide, amine, succinimidyl ester, iodoacetamide, carboxyl or sulfonyl chloride.

48. (canceled)

49. The material of claim 46 wherein the core-shell silica nanoparticles have core diameters between 2 and 2000 nm and shell thicknesses between 1 and 2000 nm.

50-51. (canceled)

52. The material of claim 46 wherein the core-shell silica nanoparticles are porous or have porous shells.

53. The material of claim 52 wherein the core-shell silica nanoparticles comprise pharmaceutical, nutraceutical, veterinary, fragrance, anti-microbial, anti-clotting or clot-inducing, biologically active, RFID active or catalytic agents.

54. (canceled)

55. The material of claim 46 wherein the core-shell silica nanoparticles comprise at least two types of dyes.

56-58. (canceled)

59. The material of claim 55 wherein at least one of the at least two types of dyes is a reference dye and at least one of the at least two types of dyes is a sensor dye.

60. The material of claim 59 wherein the reference dye and the at least one sensor dye are disposed in different shells of the single type of core-shell silica nanoparticle.

61. (canceled)

62. The material of claim 46 wherein the core-shell silica nanoparticles comprise a second type of core nanoparticle or shell material selected from the group consisting of magnetic, radio-active, tera-hertz active, plasmonically active, metal and metal oxide nanoparticles.

63. The material of claim 46 comprising a plurality of core-shell silica nanoparticle types, polymeric matrix material types, natural cellulose-based or protein-based material types, or core-shell silica nanoparticle sizes.

64. The material of claim 46 wherein the core-shell silica nanoparticles comprise a surface coating that is physically adsorbed or covalently bonded.

65. The material of claim 46 wherein the core-shell silica nanoparticle comprises:
a core;
a plurality of shells comprising shell materials; and
an external surface comprising silica.

66. The material of claim 65 wherein the shell materials are selected from the group consisting of silica, metals, oxides, organic moieties and dyes.

67. (canceled)

68. A method for deterring counterfeiting of goods of interest comprising tagging the goods with an anti-counterfeiting tag comprising the material of claim 46, or a blend or a mixture thereof.

69-73. (canceled)

74. A method for detecting a condition of interest in a subject comprising:
providing a material, wherein the material comprises:
a polymeric material, a natural cellulose-based or protein-based material, or a blend or a mixture thereof, and core-shell silica nanoparticles, wherein the core-shell silica nanoparticles are sensitive to the condition of interest;
contacting the subject with the material;
detecting change in the state of the sensitive core-shell silica nanoparticles indicative of the condition of interest; and
determining the condition of interest in the subject from the detected change.

75. The method of claim 74:
wherein:
the core-shell silica nanoparticles are pH-sensitive core-shell silica nanoparticles;
and
detecting the change in the state of the sensitive core-shell silica nanoparticles comprises detecting alteration in pH-sensitive properties of the pH-sensitive core-shell silica nanoparticles indicative of a pH change.

76. The method of claim 75 wherein:
the step of contacting the subject with the material comprises contacting sweat produced by the subject with the material, and
the condition of interest is the composition of the sweat,
the method further comprising the step of:
calculating the pH of the sweat produced by the subject from the detected change.
